(19) United States
(12) Patent Application Publication
(10) Pub. No.: US 2024/0177478 A1
(43) Pub. Date: May 30, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventors: EISABURO ITAKURA, TOKYO (JP); TETSU OGAWA, TOKYO (JP)

(21) Appl. No.: 18/551,195

(22) PCT Filed: Feb. 4, 2022
(86) PCT No.: PCT/JP2022/004456

§ 371 Date: Sep. 19, 2023

(30) Foreign Application Priority Data
Mar. 30, 2021 (JP) 2021-058513

(51) Int. Cl. G06V 20/10; G06V 10/25; G06V 10/762; G06V 10/764

(52) U.S. Cl. CPC G06V 20/188; G06V 10/25; G06V 10/762; G06V 10/764

(57) ABSTRACT

An information processing device includes an evaluation information correction unit that corrects evaluation information associated with a target area according to correction information based on the number of crops of the target area.

### TECHNICAL FIELD

The present technology relates to an information processing device, an information processing method, and a program, and particularly to a technology suitable for generation of information associated with cultivation of crops.

### BACKGROUND ART

For example, it has been attempted to achieve remote sensing of a vegetation state by capturing an image of a vegetation state of plants with use of an imaging device (camera) mounted on a small-sized flying object while moving the imaging device in the sky above a farm field.

PTL 1 discloses a technology which captures an image of a farm field and achieves remote sensing.

### CITATION LIST

### Patent Literature

[PTL 1]
Japanese Patent No. 5162890

### SUMMARY

### Technical Problem

A vegetation index can be acquired as evaluation information associated with vegetation from a farm field image captured by remote sensing. For example, an NDVI (Normalized Difference Vegetation Index) acquired from a captured image is designated as a vegetation index, and a mapping image is formed on the basis of a large number of captured images to check a wide-area NDVI image. For example, fertilization or the like is performed according to activity of vegetation for each area of the farm field with reference to such an NDVI image.

However, some NDVI values acquired from a captured image of a farm field do not accurately indicate actual activity of vegetation. This problem is caused because the captured image of the farm field includes not only a vegetation part where vegetation is present but also a soil part where vegetation is absent.

Particularly in an area containing a small number of crops and a large volume of soil, a proportion of the soil part increases in the captured image. In this case, a low NDVI value may be calculated by an influence of the soil part even in a situation where activity of vegetation in the vegetation part is high.

Accordingly, the present disclosure proposes a technology for improving accuracy of evaluation information acquired by sensing.

### Solution to Problem

An information processing device according to the present technology includes an evaluation information correction unit that corrects evaluation information associated with a target area according to correction information based on the number of crops of the target area.

The correction information is information used for correction of the evaluation information and may be any of various rates and values.

In the information processing device according to the present technology described above, it is possible that the evaluation information correction unit obtains a vegetation cover rate from the number of crops in the target area and generates the correction information on the basis of the vegetation cover rate.

The vegetation cover rate is a rate of vegetation covering a ground surface. The vegetation cover rate of the target area indicates a rate of vegetation covering a ground surface in the target area.

In the information processing device according to the present technology described above, it is possible that the evaluation information correction unit specifies a theoretical value of the evaluation information from the vegetation cover rate and generates the correction information on the basis of the theoretical value.

The theoretical value of the evaluation information is a theoretical value of evaluation information assumed for a specific vegetation cover rate.

In the information processing device according to the present technology described above, it is possible that the evaluation information correction unit specifies the theoretical value from the vegetation cover rate on the basis of reference data corresponding to a type of the crops in the target area.

For example, the reference data is data indicating a correlation between a vegetation cover rate and a theoretical value of evaluation information concerning a certain type of crops.

In the information processing device according to the present technology described above, it is possible that the evaluation information correction unit specifies the theoretical value from the vegetation cover rate on the basis of previous data previously measured in the target area.

For example, the previous data is data indicating a correlation between a vegetation cover rate previously measured and a theoretical value of evaluation information in the target area or a farm field including the target area.

In the information processing device according to the present technology described above, it is possible that the evaluation information correction unit specifies the theoretical value from the vegetation cover rate on the basis of the previous data corresponding to a condition of the target area.

For example, the condition of the target area is a climate condition or a condition associated with soil.

In the information processing device according to the present technology described above, it is possible that the target area is a partial area of a farm field, and that the evaluation information correction unit corrects evaluation information associated with multiple target areas in the farm field.

For example, evaluation information associated with the respective areas in the farm field is corrected.

In the information processing device according to the present technology described above, it is possible that the evaluation information correction unit obtains a vegetation cover rate from the number of crops for each of multiple target areas, classifies the multiple target areas into a first cluster having a high vegetation cover rate and a second cluster having a low vegetation cover rate, and corrects at least evaluation information associated with the target area classified into the second cluster.

In other words, at least the evaluation information associated with the target area having the low vegetation cover rate in the multiple target areas is corrected.

In the information processing device according to the present technology described above, it is possible that the evaluation information correction unit corrects evaluation information associated with the target area classified into the first cluster and the evaluation information associated with the target area classified into the second cluster.

In other words, the evaluation information associated with the target area having the high vegetation cover rate in the multiple target areas is corrected in addition to the evaluation information associated with the target area having the low vegetation cover rate.

In the information processing device according to the present technology described above, it is possible that the evaluation information correction unit acquires evaluation information associated with the multiple target areas at different points of time, obtains a difference between a maximum value of evaluation information in the first cluster and a maximum value of evaluation information in the second cluster, and corrects the evaluation information associated with the target area classified into the second cluster, on the basis of correction information generated from the difference.

For example, the evaluation information associated with the target area having the low vegetation cover rate is corrected considering the difference between the maximum value of the first cluster and the maximum value of the second cluster.

In the information processing device according to the present technology described above, it is possible that the evaluation information correction unit acquires evaluation information associated with the multiple target areas at different points of time, extracts a maximum value of evaluation information in the first cluster, designates the target area from which the maximum value has been extracted, as a maximum value area, obtains a theoretical value of evaluation information associated with the maximum value area on the basis of a vegetation cover rate of the maximum value area, and corrects the evaluation information associated with the multiple target areas on the basis of correction information generated from the maximum value and the theoretical value.

For example, the evaluation information associated with the multiple target areas is corrected on the basis of correction information indicating a ratio of the theoretical value of the evaluation information associated with the maximum value area to the maximum value.

In the information processing device according to the present technology described above, it is possible that the number of crops in the target area is obtained from image data of the target area.

For example, the number of crops in the target area is obtained by stand counting on the basis of image data obtained by capturing an image of the target area.

In the information processing device according to the present technology described above, it is possible that the evaluation information associated with the target area is a vegetation index.

The vegetation index includes a wide range of indexes available for specifying a state of plants.

An information processing method according to the present technology corrects evaluation information associated with a target area according to correction information based on the number of crops of the target area.

A program according to the present technology is a program causing an information processing device to execute the process of the information processing method described above.

### BRIEF DESCRIPTION OF DRAWINGS

FIG. 1 is an explanatory diagram of a state of a farm field according to an embodiment of the present technology.

FIG. 2 is a block diagram of an information processing device according to the embodiment.

FIG. 3 is an explanatory diagram of a display state of the farm field according to the embodiment.

FIG. 4 is an explanatory diagram of a grid display state according to the embodiment.

FIG. 5 is an explanatory diagram of a configuration of the farm field and an NDVI image formed on the basis of a captured image of the farm field.

FIG. 6 represents explanatory diagrams each depicting an NDVI image in NDVI measurement.

FIG. 7 represents explanatory diagrams each depicting an NDVI image in NDVI measurement achieved by soil separation.

FIG. 8 represents diagrams each illustrating an example of a correlation of vegetation indexes.

FIG. 9 is an explanatory diagram of a series of processes performed by the information processing device according to the embodiment.

FIG. 10 is an explanatory diagram of a first example of a correction process according to the embodiment.

FIG. 11 is an explanatory diagram of a functional configuration of an evaluation information correction unit in the first example of the correction process according to the embodiment.

FIG. 12 is a flowchart of the first example of the correction process according to the embodiment.

FIG. 13 is an explanatory diagram depicting different areas in the farm field.

FIG. 14 represents explanatory diagrams of a second example of the correction process according to the embodiment.

FIG. 15 is an explanatory diagram of NDVIs at different spots in the farm field.

FIG. 16 is an explanatory diagram of a functional configuration of the evaluation information correction unit in the second example of the correction process according to the embodiment.

FIG. 17 is a flowchart of the second example of the correction process according to the embodiment.

### DESCRIPTION OF EMBODIMENTS

An embodiment will hereinafter be described in the following order.
<1. Configuration of sensing system>
<2. Configuration of information processing device>
<3. NDVI measurement for farm field>
<4. Evaluation information correction process of embodiment>
<5. First example of NDVI correction process>
<6. Second example of NDVI correction process>
<7. Summary and modifications>

### <1. Configuration of Sensing System>

A sensing system according to the embodiment will initially be described.

Described in the embodiment by way of example will be sensing performed for a farm field concerning a vegetation state in the farm field.

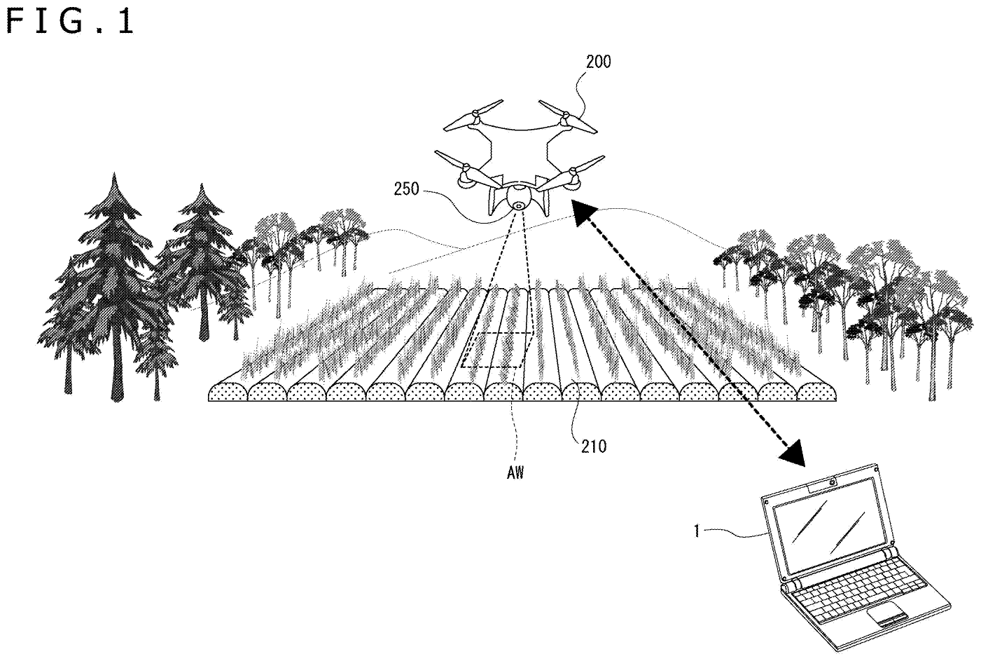

For example, as depicted in FIG. 1, remote sensing is performed for a farm field 210 concerning vegetation therein by using an imaging device 250 mounted on a flying object 200. Thereafter, a mapping image indicating vegetation evaluation information (e.g., vegetation index data) is formed on the basis of a large volume of image data obtained by this imaging.

FIG. 1 depicts a state of the farm field 210.

The flying object 200 which is small-sized is movable in the sky above the farm field 210 under wireless control by an operator, wireless automated control, or other types of control, for example.

The imaging device 250 is installed on the flying object 200 in such a position as to capture an image below the flying object 200, for example. While the flying object 200 is moving in the sky above the farm field 210 along a predetermined route, the imaging device 250 periodically captures a still image, for example. In this manner, an image of a range AW in an imaging visual field can be captured at respective points of time.

Examples assumed to be employed as the imaging device 250 mounted on the flying object 200 include a visible light image sensor (an image sensor for imaging visible light in R (red), G (green), and B (blue)), a camera for capturing NIR (Near Infra Red: near infrared region) images, a multispectral camera for capturing images in multiple wavelength bands, a hyper-spectral camera, a Fourier transform infrared spectrophotometer (FTIR: Fourier Transform Infrared Spectroscopy), and an infrared sensor. Needless to say, multiple types of cameras (sensors) may be mounted on the flying object 200.

The multispectral camera also assumed to be employed is such a camera which captures NIR images and R (red) images and which is capable of calculating an NDVI (Normalized Difference Vegetation Index) from each obtained image, for example. As will be described in detail below, an NDVI is a vegetation index indicating characteristics of plants and may be used as an index for indicating a distribution state of vegetation and activity.

Tag information is added to an image captured and obtained by the imaging device 250. The tag information includes imaging date and time information, position information (latitude/longitude information) as GPS (Global Positioning System) data, information indicating flight altitude of the flying object 200 during imaging, imaging device information (e.g., individual identification information and model information associated with a camera), information associated with respective pieces of image data (information indicating items such as an image size, a wavelength, and an imaging parameter), and other information.

The image data and the tag information obtained by the imaging device 250 attached to the flying object 200 in the manner described above are acquired by an information processing device 1.

For example, the image data and the tag information are transferred via wireless communication, network communication, or the like between the imaging device 250 and the information processing device 1. Examples assumed to be employed as the network include the Internet, a home network, a LAN (Local Area Network) or the like, a satellite communication network, and other various types of networks.

Alternatively, the image data and the tag information are transferred to the information processing device 1 in a form such as a storage medium (e.g., memory card) attached to the imaging device 250 and read by the information processing device 1.

The information processing device 1 performs various processes on the basis of the image data and tag information thus acquired.

Specifically, the information processing device 1 generates evaluation information associated with vegetation in the farm field 210, according to the image data and the tag information, and corrects the evaluation information on the basis of data associated with the farm field 210 to be described below. Moreover, the information processing device 1 performs a process for presenting the corrected evaluation information to a user in the form of an image, for example.

The information processing device 1 arranges and stitches the range AW of a subject in each of multiple images captured by the imaging device 250, according to position information associated with the respective images, to form a mapping image, for example. In this manner, the information processing device 1 can form such an image indicating evaluation information associated with vegetation in the entire farm field 210, for example.

The information processing device 1 is implemented in the form of a PC (personal computer), an FPGA (field-programmable gate array), a terminal device such as a smartphone and a tablet, or the like, for example.

Note that, while FIG. 1 illustrates the information processing device 1 as a device separated from the imaging device 250, an arithmetic device (e.g., microcomputer) constituting the information processing device 1 may be provided within a unit including the imaging device 250, for example.

### <2. Configuration of Information Processing Device>

Described will be the information processing device 1 which is included in the sensing system described above and is configured to acquire image data from the imaging device 250 and perform various processes.

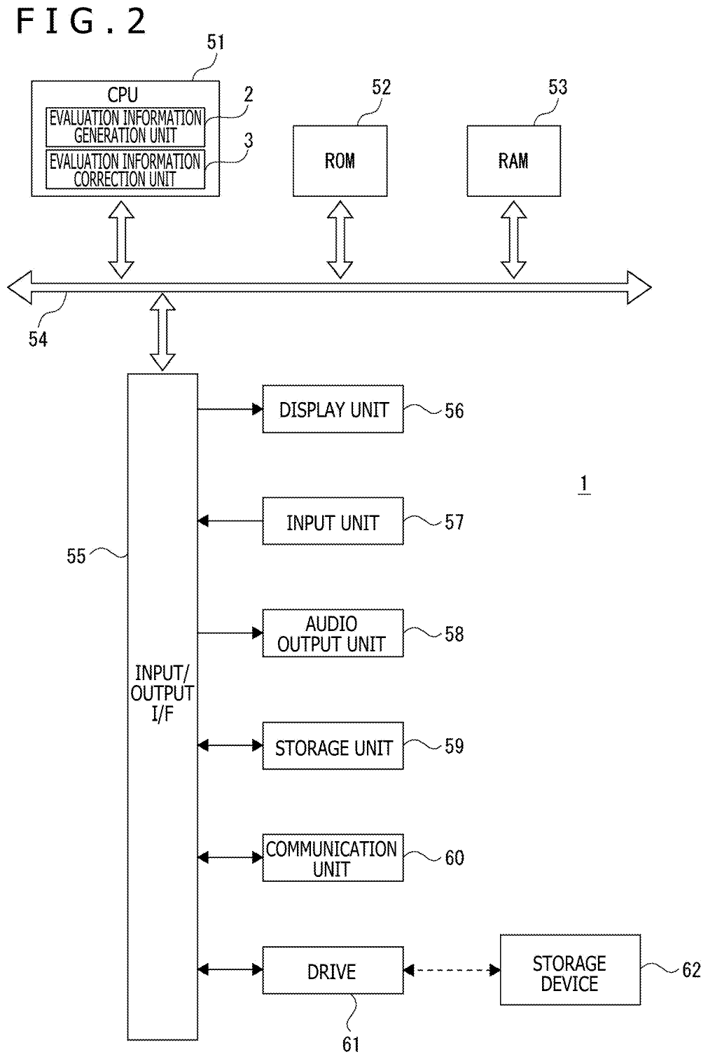

FIG. 2 depicts a hardware configuration of the information processing device 1. The information processing device 1 includes a CPU (Central Processing Unit) 51, a ROM (Read Only Memory) 52, and a RAM (Random Access Memory) 53.

The CPU 51 executes various processes in accordance with a program stored in the ROM 52 or a program loaded from a storage unit 59 to the RAM 53. Data and the like necessary for the CPU 51 to execute various processes are also stored in the RAM 53 as necessary.

The CPU 51, the ROM 52, and the RAM 53 are connected to one another via a bus 54. An input/output interface 55 is further connected to the bus 54.

A display unit 56 including a liquid crystal panel, an organic EL (Electroluminescence) panel, or the like, an input unit 57 including a keyboard, a mouse, and the like, an audio output unit 58, the storage unit 59, a communication unit 60, and other components are connectable to the input/output interface 55.

The display unit 56 may be either formed integrally with the information processing device 1 or formed as a separate device.

The display unit 56 displays captured images, various calculation results, and the like on a display screen in accordance with an instruction from the CPU 51. The display unit 56 further displays various operation menus, icons, messages, and the like, i.e., items displayed by a GUI (Graphical User Interface), in accordance with an instruction from the CPU 51.

The input unit 57 refers to an input device operated by the user of the information processing device 1.

Examples assumed to be employed as the input unit 57 include various operators and operation devices such as a keyboard, a mouse, keys, a dial, a touch panel, a touch pad, and a remote controller.

An operation performed by the user is detected by the input unit 57, and a signal corresponding to the input operation is interpreted by the CPU 51.

The audio output unit 58 includes a speaker, a power amplifier unit for driving the speaker, and the like to output necessary sound.

The storage unit 59 includes a storage medium such as an HDD (Hard Disk Drive) and a solid-state memory. For example, a program for implementing various functions of the CPU 51 is stored in the storage unit 59. The storage unit 59 is also used to store image data and various types of additional data acquired by the imaging device 250 and various types of data generated by the CPU 51.

The communication unit 60 performs a communication process achieved via a network such as the Internet, and communicates with respective peripheral apparatuses.

The communication unit 60 in some cases is a communication device which communicates with the flying object 200 or the imaging device 250, for example.

A drive 61 is further connected to the input/output interface 55 as necessary. A storage device 62 such as a memory card is attached to the drive 61 such that data is written and read to and from the storage device 62.

For example, a computer program read from the storage device 62 is installed in the storage unit 59 as necessary, and data processed by the CPU 51 is stored in the storage device 62. Needless to say, the drive 61 may be a recording/reproducing drive provided for a removable storage medium such as a magnetic disk, an optical disk, and a magneto-optical disk. Each of the magnetic disk, the optical disk, the magneto-optical disk, and the like herein is also considered as a form of the storage device 62.

Note that the information processing device 1 according to the embodiment is not limited to the single information processing device (computer device) 1 having the hardware configuration in FIG. 2 and may include multiple systematized computer devices. The multiple computer devices may be systematized using a LAN or the like or may be disposed at remote locations and connected via a VPN (Virtual Private Network) or the like using the Internet of the like. The multiple computer devices may include a computer device available by a cloud computing service.

Moreover, the information processing device 1 in FIG. 2 can be implemented by a personal computer such as a computer of a stationary type and of a laptop type, or a portable terminal such as a tablet terminal and a smartphone. Further, the information processing device 1 according to the present embodiment can be mounted on an electronic apparatus having a function of the information processing device 1, such as a measuring device, a television device, a monitoring device, an imaging device, and an equipment management device.

For example, the information processing device 1 having the hardware configuration described above has an arithmetic function achieved by the CPU 51, a storage function achieved by the ROM 52, the RAM 53, and the storage unit 59, a data acquisition function achieved by the communication unit 60 and the drive 61, and an output function achieved by the display unit 56 and the like and is allowed to obtain the various functional configurations by functions of installed software.

The information processing device 1 according to the embodiment includes an evaluation information generation unit 2 and an evaluation information correction unit 3 depicted in FIG. 2.

These processing functions are implemented by software started by the CPU 51.

A program constituting this software is downloaded from a network or read from the storage device 62 (e.g., removable storage medium), and installed in the information processing device 1 in FIG. 2. Alternatively, this program may be stored in the storage unit 59 or the like beforehand. Thereafter, this program is started by the CPU 51 to implement the functions of the respective units described above.

Moreover, storage of arithmetic processes and results of the respective functions is practiced using a storage area of the RAM 53 or a storage area of the storage unit 59, for example.

The evaluation information generation unit 2 is a function which acquires image data as a processing target and tag information added to the image data and generates evaluation information indicating a state of the farm field 210. For example, image data (captured image) captured by the imaging device 250 is stored in the storage unit 59 or the like. The CPU 51 reads specific data of the image data and designates the read data as a target for an evaluation information generation process.

For example, the evaluation information generation unit 2 forms a vegetation index image as evaluation information. Described in the embodiment will be an example where the evaluation information generation unit 2 forms an NDVI image as the evaluation information.

The evaluation information correction unit 3 is a function which corrects evaluation information.

For example, the evaluation information correction unit 3 reads evaluation information generated by the evaluation information generation unit 2 from the storage unit 59 or the like and designates the read evaluation information as a target for a correction process. Moreover, the evaluation information correction unit 3 reads data associated with the farm field 210 from the storage unit 59 or the like and corrects evaluation information corresponding to a processing target with use of correction information generated on the basis of this data.

For example, the evaluation information correction unit 3 reads data indicating the number of crops in a target area of the farm field 210 from the storage unit 59 or the like, generates correction information on the basis of the number of crops, and corrects evaluation information associated with this target area on the basis of the generated correction information. In addition, the evaluation information correction unit 3 outputs corrected evaluation information.

The evaluation information generated by the evaluation information generation unit 2 and the corrected evaluation information output from the evaluation information correction unit 3 may be stored in the storage unit 59 or transmitted to an external apparatus by the communication unit 60. In this aspect, the CPU 51 may have a function as a communication control unit that transmits output information generated by the evaluation information generation unit 2 or the evaluation information correction unit 3.

In addition, the evaluation information correction unit 3 uses data which is associated with the farm field 210 and is stored in the storage unit 59 or the like, to correct evaluation information. Accordingly, the CPU 51 may further have a function of generating data associated with the farm field 210. For example, as a function of generating data indicating the number of crops, the CPU 51 may have a function of counting crops on the basis of image data obtained by imaging a target area of the farm field 210 and a function of calculating the number of crops per unit area or the like on the basis of a count number of crops. The evaluation information correction unit 3 may use data which is calculated by the CPU 51 having the above functions and is stored in the storage unit 59 or may use data which is acquired from an external apparatus and is stored in the storage unit 59.

In addition, while not depicted in the figure, the CPU 51 has a function of performing display control of the display unit 56, a process for acquiring operation information input from the input unit 57, and the like and achieves presentation of various types of information stored in the storage unit 59, recognition of an operation performed by the user, and the like.

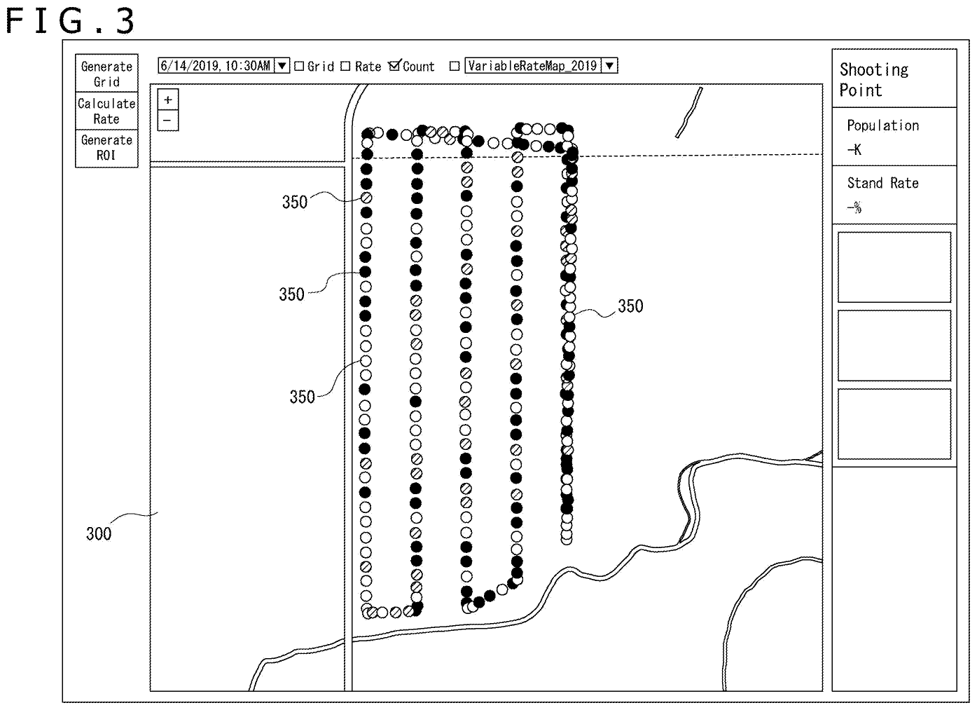

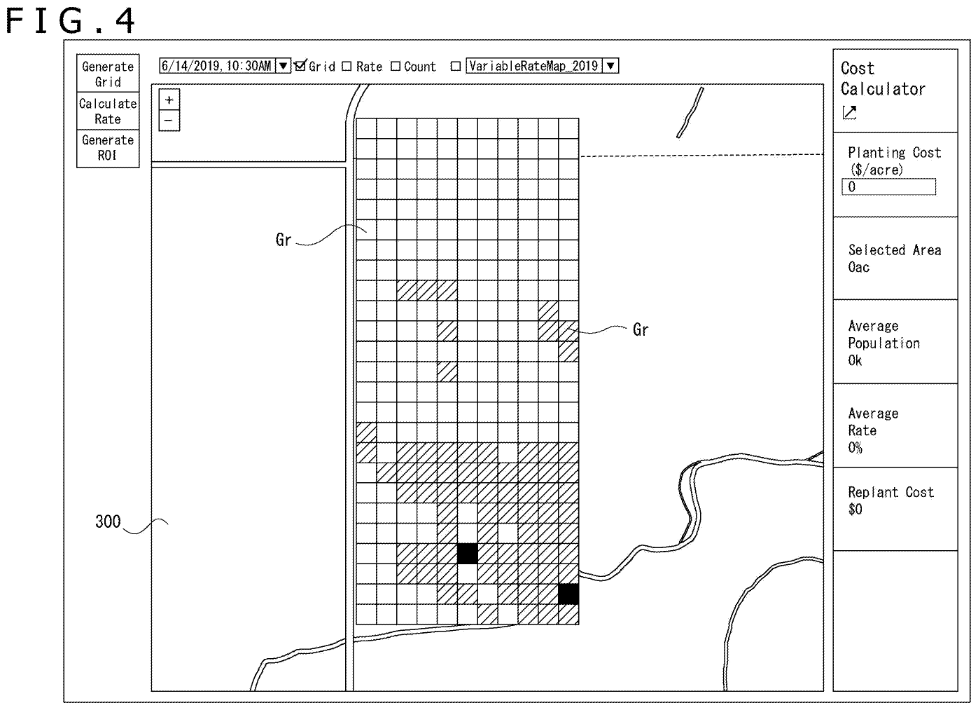

FIGS. 3 and 4 each depict an example of a user interface screen (hereinafter a “user interface” will be expressed as a “UI”) displayed on the display unit 56 or the like by the function of the CPU 51.

FIG. 3 depicts an example where a map image containing the farm field 210 is displayed in a map region 300 on the UI screen. FIG. 3 further depicts an example where multiple sample position marks 350 are displayed in the map region 300. The sample position marks 350 each indicate an imaging position of one image data (sample), for example, and are displayed by color-coded display in three levels (displayed in three types of circles, i.e., a white circle, a hatched circle, and a black circle in the figure) according to values (germination rates) obtained by converting the number of crops calculated from the image data into the number of crops per unit area.

FIG. 4 depicts a state where a grid having a grid pattern is displayed in the map region 300. This grid indicates an area definition image and a display defining a partial area of the farm field 210 with grid lines. Specifically, each of areas formed by dividing the farm field 210 is presented to the user as a range divided by the grid (a square divided by the grid). For example, a grid size can be set to any size by the user.

Each area represented as a square of the grid (hereinafter also referred to as a grid area Gr) is displayed in an image form determined according to various rates or evaluation values calculated for the corresponding area. For example, a rate such as a germination rate and a vegetation cover rate described below, an average NDVI value, and the like are displayed for each of the grid areas Gr.

For example, FIG. 4 depicts color-coded display in three levels (display of three types, i.e., a white square, a hatched square, and a black square in the figure) according to a germination rate in each area. For example, color-coded display is given in the following manner; green (black square in the figure) if the germination rate is 98% or higher; yellow (hatched square in the figure) if the germination rate is lower than 98% but 90% or higher; and red (white square in the figure) if the germination rate is lower than 90%. Note that the germination rate in each of the grid areas Gr can be obtained by averaging sample position marks within the area or interpolation calculation using adjoining sample position marks, for example.

The user can check the germination rate and the average NVDI value for each of the grid areas Gr on the basis of this color-coded display.

Moreover, while not depicted in the figure, an action such as fertilization and details of the action can be designated via the UI screen for each of the grid areas Gr displayed in the map region 300. For example, a fertilizer quantity rate map called “prescription” can be created according to designation of appropriate values of fertilizers by the user for each area with reference to the germination rate and the NDVI value for each of the grid areas Gr. For example, the created fertilizer quantity rate map is exported as an instruction file from the information processing device 1. The instruction file is acquired by a tractor or the like, and variable fertilization is thus achieved on the basis of the fertilizer quantity rate map.

### <3. NDVI Measurement for Farm Field>

Described in the embodiment will be an example where the information processing device 1 forms, as evaluation information, an NDVI image of a farm field corresponding to an observation target and designates the formed NDVI image as a target for a correction process.

An NDVI is a vegetation index indicating activity of a plant and is calculated using a captured image acquired from a multispectral camera which is capable of simultaneously capturing images having two wavelengths, i.e., a RED wavelength (red) and an NIR wavelength (near infrared) (hereinafter referred to as an R image and an NIR image, respectively), for example.

Pixel values indicating RED intensity and NIR intensity acquired from the R image and the NIR image, respectively, are measured from reflection light reflected on a subject. A plant absorbs light having a red wavelength through chlorophyll to perform photosynthesis and releases not absorbed light from leaves by diffuse reflection. Hence, a leaf absorbing more light having a reddish wavelength light can be determined as a leaf having higher chlorophyll concentration and exhibiting higher activity. Accordingly, an NDVI is used for a purpose of estimation of chlorophyll concentration.

An NDVI value corresponding to each pixel of a captured image can be calculated from the R image and the NIR image by using the following (equation 1). In (equation 1), RED and NIR represent intensity (pixel value) at a RED wavelength (approximately 630 to 690 nm) and intensity (pixel value) at an NIR wavelength (approximately 760 to 900 nm), respectively.

NDVI=(NIR−RED)/(NIR+RED) (Equation 1)

An NDVI value of a pixel corresponding to vegetation is high while an NDVI value of a pixel corresponding to soil is low. Moreover, as for pixels corresponding to vegetation, an NDVI value of vegetation exhibiting high activity is higher than an NDVI value of vegetation exhibiting low activity.

An NDVI image is formed on the basis of a calculation result obtained by calculating NDVI values corresponding to respective pixels of a captured image by using (equation 1). A pixel value set for each of the pixels of the NDVI image corresponds to an NDVI value calculated as above. For example, each of the NDVI values is set within a range from 0.0 to 1.0.

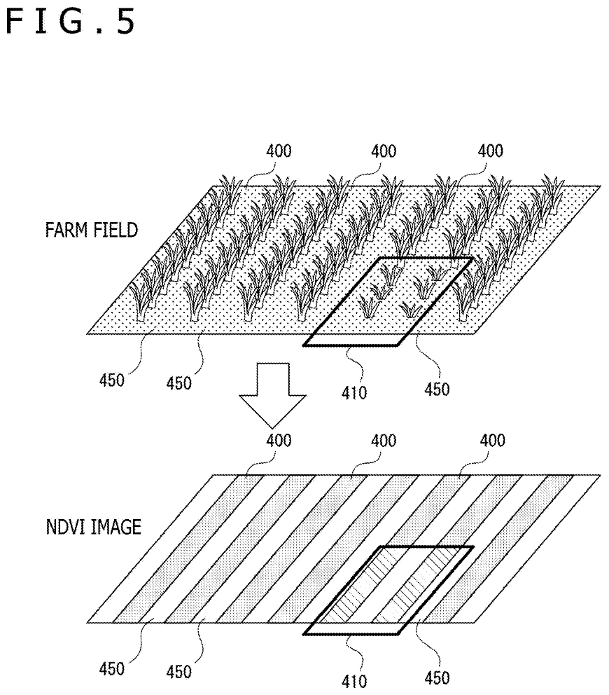

Subsequently, NDVI measurement performed for the farm field will specifically be described with reference to FIG. 5. FIG. 5 depicts a part of the farm field 210 and an NDVI image formed on the basis of image data obtained by imaging this part.

The farm field 210 partially depicted in FIG. 5 is a farm field where grains such as corn, soy, and rice, vegetables such as green onions, cabbages, Chinese cabbages, and spinaches, and crops such as flowers and trees are cultivated, for example.

Crops are planted along lines such as linear ridges, for example, and constitute a vegetation part 400 of the farm field 210.

Multiple vegetation parts 400 are spaced apart from each other and provided at fixed intervals in the farm field 210. A portion between each adjoining pair of the vegetation parts 400 constitutes a soil part 450 where no crop is planted. This manner of arrangement of the vegetation parts 400 with a clearance left therebetween offers various advantages such as allowing a large amount of sunlight to reach the cultivation target crops and facilitating execution work.

Accordingly, the farm field 210 has a configuration as a mixture of the vegetation parts 400 where crops are present and the soil parts 450 where crops are absent. Moreover, the farm field 210 includes a poor growth area 410 exhibiting low activity of planted crops. Activity of crops lowers in the vegetation parts 400 contained in the poor growth area 410.

The NDVI image depicted in FIG. 5 is a diagram schematically illustrating an NDVI image formed on the basis of a captured image of a part of the farm field 210.

When an image of the farm field 210 having a mixture of the vegetation parts 400 and the soil parts 450 is captured from the sky with use of the imaging device 250 attached to the flying object 200, a captured image to be obtained contains a mixture of the vegetation parts 400 and the soil parts 450. The NDVI image formed on the basis of such a captured image is an image indicating a mixture of NDVI values of the vegetation parts 400 and NDVI values of the soil parts 450.

In the schematic diagram of FIG. 5, each of black portions represents an area indicating high NDVI values (close to 1.0) while each of white portions represents an area indicating low NDVI values (close to 0.0).

The NDVI image depicted in FIG. 5 suggests that each pixel corresponding to the vegetation parts 400 not contained in the poor growth area 410 has a high NDVI value. Hence, it is obvious that activity of vegetation is high in the vegetation parts 400 not contained in the poor growth area 410. On the other hand, it is suggested that each pixel corresponding to the soil parts 450 has a low NDVI value.

For example, when an average value of overall pixel values (NDVI values) of this NDVI image is calculated, the calculated average value of the NDVI values is lower than each NDVI value of the pixels corresponding to the vegetation parts 400 due to an influence of the soil parts 450 having low NDVI values. Accordingly, accurate activity of the vegetation parts 400 contained in the image is not acquirable on the basis of the average value of the NDVI values in the image.

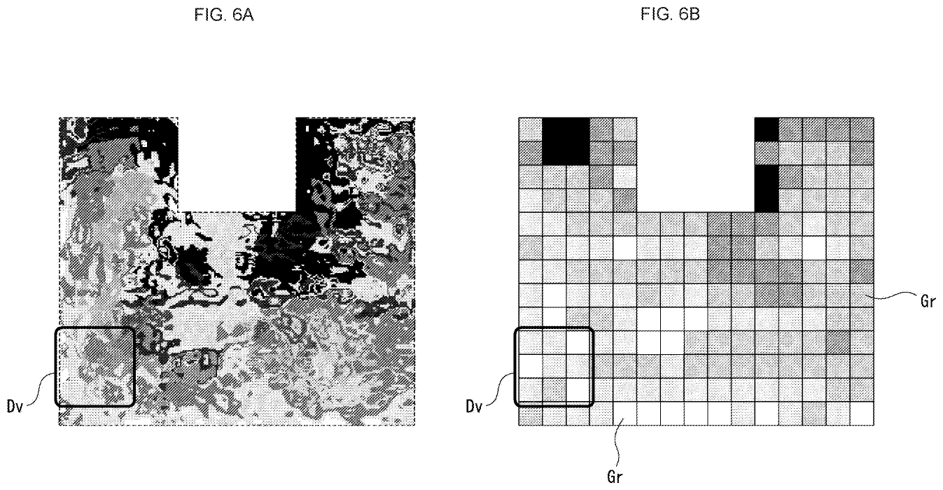

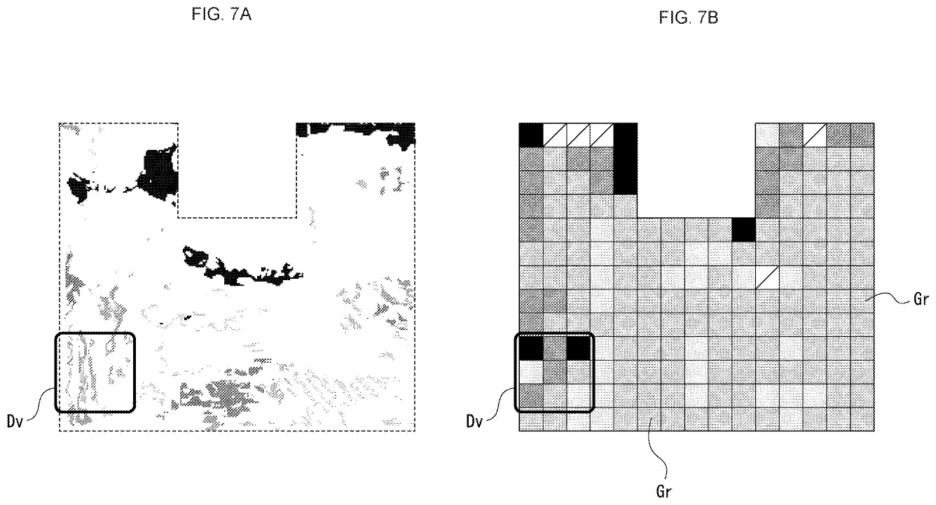

For solving this problem, it is considered to adopt such a method which separates soil and shadows from the captured image and measures NDVIs of only plants and the vegetation parts located in sunny areas. NDVI measurement achieved by soil separation will be described herein with reference to FIGS. 6 and 7.

FIG. 6A schematically depicts an NDVI image formed on the basis of a captured image of a farm field of crops (corn) in an initial stage of growth.

FIG. 6B is an NDVI image obtained after grid averaging, where an average NDVI value is calculated and displayed for each of the grid areas Gr produced by dividing the NDVI image in FIG. 6A into 25 meters square grid units. Each of the grid areas Gr indicates color-coded display in 20 levels from 0.0 represented in red to 1.0 represented in green (display in shading gradation from white to black in the figure) according to an average NDVI value of each area. The NDVI image in FIG. 6B is an image of the crops in the initial stage of growth. Hence, the soil parts occupy a major portion of the farm field 210. As a result, a large number of grid areas Gr in a section Dv each have an average NDVI value lower than 0.4, for example, and therefore, many grid areas are displayed in a color close to red (gradation close to white in the figure).

FIG. 7A depicts an NDVI image obtained after soil separation, which is an image obtained by performing a soil separation process for a captured image of the same farm field as the farm field in FIG. 6A to separate the soil parts from the vegetation parts, and then calculating NDVIs after removal of the soil parts.

FIG. 7B is an NDVI image obtained after grid averaging, where an average NDVI value is calculated and displayed for each of the grid areas Gr produced by dividing the soil-separated NDVI image in FIG. 7A into 25 meters square grid units. Similarly to FIG. 6B, each of the grid areas Gr indicates color-coded display in 20 levels from 0.0 represented in red to 1.0 represented in green (display in shading gradation from white to black in the figure) according to the NDVI value of each area. In addition, each of the grid areas Gr where no average value is calculated due to absence of the vegetation part is displayed as a blank (hatched display in the figure).

Compared with the NDVI image obtained after grid averaging in FIG. 6B, the entire NDVI values are higher in FIG. 7B, and more grid areas Gr are displayed in a color close to green (gradation close to black in the figure). This display is produced because the NDVI values are calculated on the basis of only pixels in the vegetation parts after removal of the soil parts from the captured image corresponding to the NDVI calculation target.

This manner of separation of the soil and the shadows with high resolution allows acquisition of NDVI values of only plants and plants in sunny areas, and therefore increases an estimation ability of the NDVIs measured from the captured image for estimating chlorophyll concentration. However, NDVI measurement for a large-scale farm by soil separation with high resolution requires imaging at low latitude so as to increase resolution. Hence, a long time is required for achieving this measurement due to a limited flyable distance with a battery of a drone or the like. It is therefore preferable to correct NDVI values calculated from a captured image, instead of the NDVI measurement based on soil separation.

### <4. Evaluation Information Correction Process of Embodiment>

According to the embodiment, NDVI values lowered by the influence of the soil parts as described above are corrected on the basis of correction information based on the numbers of crops in the respective areas of the farm field 210. Specifically, the NDVI values are corrected on the basis of vegetation cover rates obtained from the numbers of crops in the respective areas.

A vegetation cover rate (Vegetation Fraction) refers to a proportion of vegetation covering a ground surface (soil) and is expressible by a value in a range from 0.0 to 1.0 on an assumption that 1.0 indicates a state where vegetation covers the ground surface at a rate of 100%, for example.

For example, in a case where a vegetation cover rate of a target area is close to 100% (i.e., a proportion of a vegetation part in a captured image corresponding to a calculation target is close to 100%) in calculation of an NDVI value from the captured image of the target area in a farm field, an NDVI value calculated from the captured image is a value equivalent to an actual NDVI value of the vegetation part in the target area. On the other hand, in a case where a vegetation cover rate of a target area is low (i.e., a proportion of a vegetation part in a captured image corresponding to a calculation target is small), a calculated NDVI value is lower than an actual NDVI value of the vegetation part in the target area.

According to the embodiment, therefore, an NDVI value of a target area calculated from a captured image is corrected according to a vegetation cover rate for each target area in consideration of such a relation between the vegetation cover rate of the target area and the NDVI value calculated from the captured image.

The vegetation cover rate of the target area can be calculated from a germination rate based on the number of crops in the target area.

The “crops” refers to crops that are planted and have germinated in the farm field. Each of the crops is also called a stand. The “number of crops” in the target area refers to the number of crops in the target area and is acquired on the basis of image data obtained by imaging the target area. The number of crops acquired in this manner is also called a “stand count value.”

According to the embodiment, the germination rate in the target area is acquired with reference to data of the number of crops already calculated for the target area. In addition, in a case where the germination rate has already been calculated on the basis of data of the number of crops in the target area, data of the calculated germination rate may be used.

In a case of management of a farm field using remote sensing, stand counting is carried out in an initial stage of growth of crops in some cases. Stand counting refers to counting the number of crops in each area in the farm field on the basis of image data obtained by imaging each area after planting, in order to check a planting problem or the like of the crops. The number of crops counted in this manner is also called a stand count value. In a case where stand counting has been carried out for the farm field, the number of crops in each area obtained by this counting and data of the germination rate calculated from the number of crops are already known. Accordingly, these pieces of data are utilized in the embodiment.

For example, it is possible to use a theoretical NDVI value corresponding to a vegetation cover rate to correct an NDVI value on the basis of the vegetation cover rate. The theoretical NDVI value herein refers to a theoretical value of an NDVI assumed for a specific vegetation cover rate.

For example, the theoretical NDVI value can be acquired on the basis of a vegetation cover rate by utilizing a correlation between the vegetation cover rate and the NDVI value. In vegetation ecology, it is known that there is a correlation between an LAI (Leaf Area Index), a vegetation cover rate, and an NDVI. Particularly in a case where chlorophyll concentration is fixed, a vegetation cover rate and an NDVI are highly correlated with each other. Accordingly, a theoretical NDVI value can be acquired by utilizing the relation between these indexes.

Described herein will be a method which acquires a theoretical NDVI value on the basis of a vegetation cover rate calculated from a germination rate in a target area.

Initially, an LAI is obtained from a germination rate. An LAI can be obtained from a germination rate by using the following (equation 2).

LAI (leaf area index)=number of leaves (per plant)×area per leaf (m²/(number of leaves))×cultivation density (=germination rate) ((number of plants)/m²) (Equation 2)

Thereafter, a vegetation cover rate is acquired from the LAI. A correlation between an LAI and a vegetation cover rate differs for each type of crops. Accordingly, a vegetation cover rate for a particular LAI is acquired with reference to reference data indicating a correlation between an LAI and a vegetation cover rate in correspondence with the type of crops.

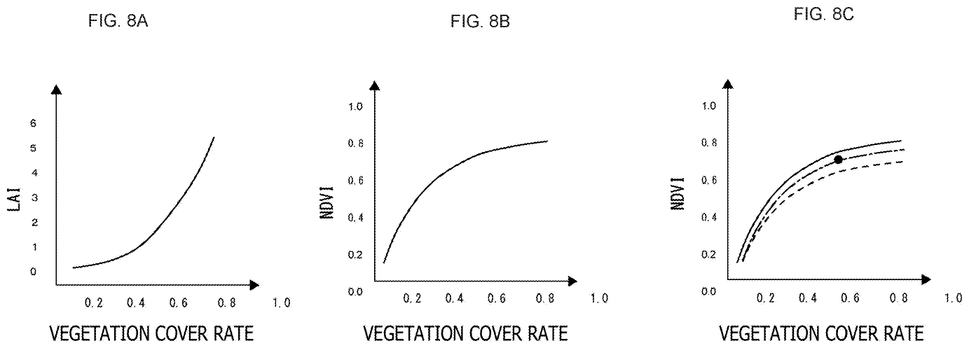

FIG. 8A depicts an example of graph information indicating a relation between an LAI and a vegetation cover rate concerning a specific type of crops. A vertical axis represents LAIs while a horizontal axis represents vegetation cover rates. A solid line in the graph represents a correlation between an LAI and a vegetation cover rate.

Finally, a theoretical NDVI value is specified on the basis of the vegetation cover rate.

A correlation between a vegetation cover rate and an NDVI value differs for each type of crops. Accordingly, a theoretical NDVI value corresponding to a particular vegetation cover rate is acquired with reference to reference data indicating a correlation between a vegetation cover rate and an NDVI value in correspondence with the type of crops in the target area.

FIG. 8B depicts an example of graph information indicating a relation between a vegetation cover rate and an NDVI value concerning a specific type of crops. A vertical axis represents NDVIs while a horizontal axis represents vegetation cover rates. A solid line in the graph represents a correlation between a vegetation cover rate and an NDVI value on the basis of measurement values measured by an experiment conducted for the specific type of crops.

Alternatively, the theoretical NDVI value may be specified with reference to previous data of the farm field containing the target area as a processing target. The previous data of the farm field is statistic data previously measured in the farm field and includes measurement data indicating a correlation between a vegetation cover rate and an NDVI value for each season and average value data indicating a correlation between a vegetation cover rate and an NDVI value obtained from measurement average values in a previous season, for example.

FIG. 8C depicts an example of graph information indicating a correlation between a vegetation cover rate and an NDVI value concerning a type of crops similar to the type in FIG. 8B. A solid line in the graph represents a correlation between a vegetation cover rate and an NDVI value on the basis of reference data corresponding to the type of crops as in FIG. 8B, while a broken line represents a correlation based on average value data in the farm field. For example, if the farm field corresponding to the processing target has a climate condition similar to that of an average year, a theoretical NDVI value corresponding to a specific vegetation cover rate is obtained with reference to the correlation indicated by the broken line. In addition, a one-dot chain line in the graph in FIG. 8C represents a correlation based on measurement data in a specific season. A correlation between a vegetation cover rate and an NDVI value is changeable according to various conditions such as a climate and soil. Accordingly, a more appropriate theoretical value can be acquired by referring to measurement data in a season similar to a condition of the farm field corresponding to the processing target. For example, in a case where the farm field corresponding to the processing target has a climate condition similar to the climate condition of the season indicated by the one-dot chain line, a theoretical value is obtained with reference to the correlation indicated by the one-dot chain line. Specifically, in a case where the vegetation cover rate is “0.5” as indicated by a black circle in the figure, for example, an NDVI value “0.7” corresponding to the vegetation cover rate “0.5” in the correlation indicated by the one-dot chain line is designated as the theoretical NDVI value.

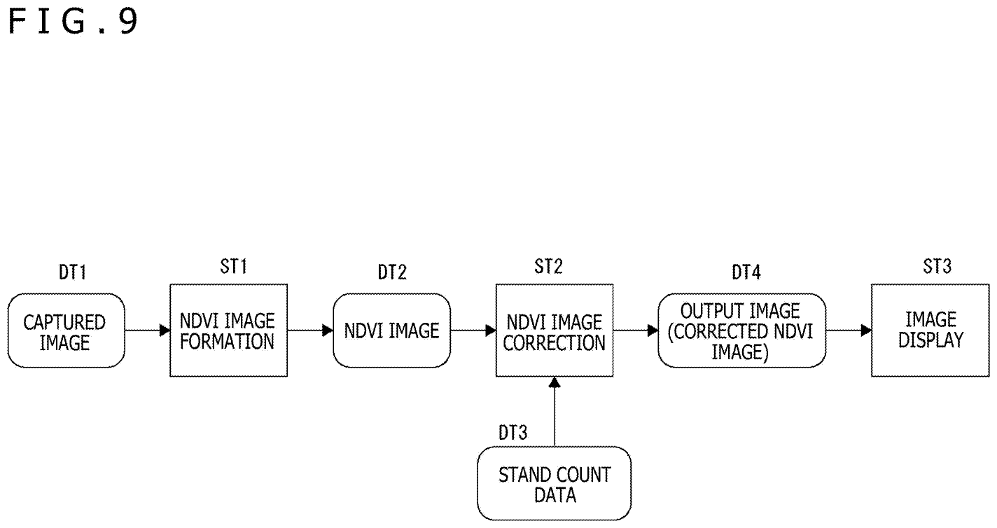

FIG. 9 depicts an operation performed to correct evaluation information according to the embodiment. Described in the embodiment will be an example which forms an NDVI image of a farm field including a target area and corrects an average NDVI value of the target area in the NDVI image.

NDVI image formation ST1 is a process which acquires a captured image DT1 of a farm field including a target area corresponding to a processing target and forms an NDVI image DT2 on the basis of the captured image DT1.

NDVI image correction ST2 is a process which corrects an average NDVI value of the target area in the NDVI image DT2. Specifically, the NDVI image correction ST2 acquires stand count data DT3 of the target area and corrects the average NDVI value of the target area according to correction information based on the stand count data DT3. In a case where the NDVI image DT2 contains multiple target areas, the average NDVI value is corrected for each of the target areas. Further, a correction NDVI image DT4 based on the corrected average NDVI value is output.

Note that the stand count data DT3, which is data indicating the number of crops in the target area, for example, is not required to be data indicating the number of crops itself. For example, the stand count data DT3 may be data on the basis of which the number of crops in the target area can be calculated, or data indicating a germination rate obtained from the number of crops in the target area.

Image display ST3 is a process which causes the display unit 56 or the like to display the corrected NDVI image DT4 in the form depicted in FIG. 4, for example.

First and second examples of an NDVI correction process will be hereinafter described as an example of the NDVI image correction ST2.

### <5. First Example of NDVI Correction Process>

In the first example of the NDVI correction process, a vegetation cover rate is obtained for each target area, and an average NDVI value is corrected on the basis of correction information corresponding to the vegetation cover rate for each target area.

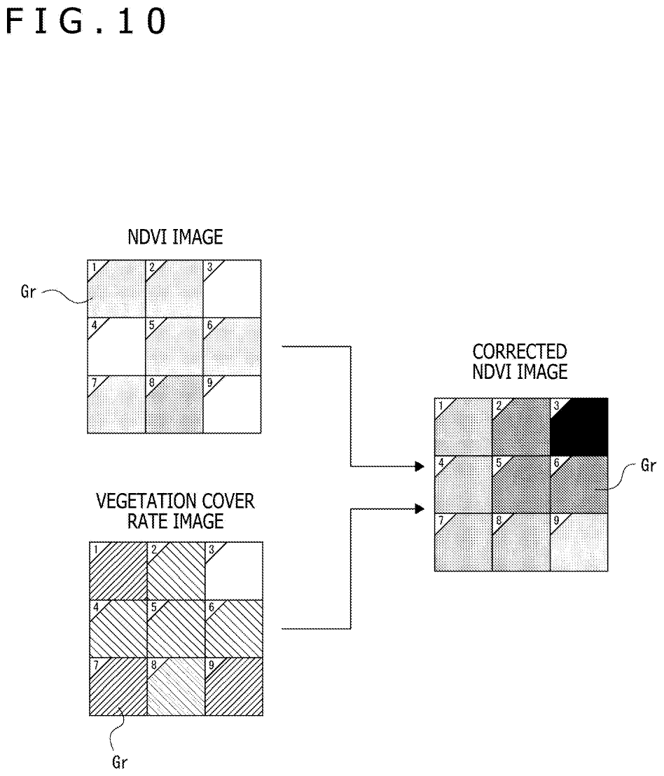

A correction example of the first example will specifically be described with reference to FIG. 10. In this correction example, correction is made for each of the grid areas Gr contained in the section Dv in the NDVI image of the farm field depicted in FIGS. 6 and 7, as a target area.

An NDVI image depicted in FIG. 10 is an enlarged illustration of the section Dv in the NDVI image depicted in FIG. 6B obtained after grid averaging. The respective grid areas Gr contained in the section Dv are given numbers “1” to “9” for convenience of explanation. The respective grid areas Gr are expressed in such a manner as an area “1” and an area “2,” for example. It is apparent from this NDVI image that an average NDVI value of the area “8” is highest and an average NDVI value of each of the areas “3,” “4,” and “9” is lowest in the section Dv.

A vegetation cover rate image depicted in FIG. 10 is an illustration indicating vegetation cover rates of the respective grid areas Gr contained in the section Dv. In the vegetation cover rate image, each of the grid areas Gr is displayed by color-coded display in 20 levels according to the vegetation cover rate in such a manner that white represents 0% and dark blue represents 100% (displayed with gradation of fineness of shading from white to shading in the figure). For example, a vegetation cover rate of the area “8” is highest, and a vegetation cover rate of each of the areas “1,” “7,” and “9” is equally high next to the area “8” in the section Dv. On the other hand, a vegetation cover rate of each of the areas “2,” “4,” “5,” and “6” is equally low, and a vegetation cover rate of the area “3” is lowest.

A corrected NDVI image depicted in FIG. 10 is an NDVI image obtained by correcting the average NDVI values of the respective grid areas Gr indicated in the NDVI image in FIG. 10 according to the vegetation cover rates of the respective grid areas Gr indicated in the vegetation cover rate image in FIG. 10.

For this correction, the average NDVI values are corrected in different correction levels according to the vegetation cover rates of the respective grid areas Gr. Specifically, the average NDVI value is not corrected for “8” having the highest vegetation cover rate, and the average NDVI value is corrected to be raised by “+1 level” for each of “1,” “7,” and “9” having the second highest vegetation cover rate. Moreover, the NDVI value is corrected to be raised by “+2 level” for each of “2,” “4,” “5,” and “6,” while the NDVI value is corrected to be raised by “+3 level” for “3.” Specifically, the correction level is raised higher for the grid area Gr having a lower vegetation cover rate.

After this correction, for example, the area “3,” which is one of the grid areas Gr having the lowest average NDVI value in the section Dv in the NDVI image before correction, is changed to the grid area Gr having the highest average NDVI value in the section Dv in the corrected NDVI image. Moreover, the area “8,” which is an area having the highest average NDVI value in the NDVI image before correction, is changed to the grid area Gr having a low average NDVI value in the section Dv in the corrected NDVI image.

As described above, values close to corresponding values in FIG. 7B for which the soil separation process has been executed are acquirable by correcting the average NDVI values in the respective grid areas Gr on the basis of the correction information corresponding to the vegetation cover rates.

Moreover, the user is allowed to appropriately recognize activity of vegetation in the respective areas on the basis of display of the corrected NDVI image depicted in FIG. 10 on the display unit 56 or the like. For example, with reference to an ordinary NDVI image, the area “8” looks like an area having a high average NDVI value and corresponds to an area exhibiting high activity of vegetation. However, with reference to the corrected NDVI image and the vegetation cover rate image, the area “8” has a high vegetation cover rate but a low average NDVI value, and therefore is recognized as an area exhibiting low activity of vegetation. Accordingly, the user can determine that an action such as fertilization is necessary for the area “8,” for example.

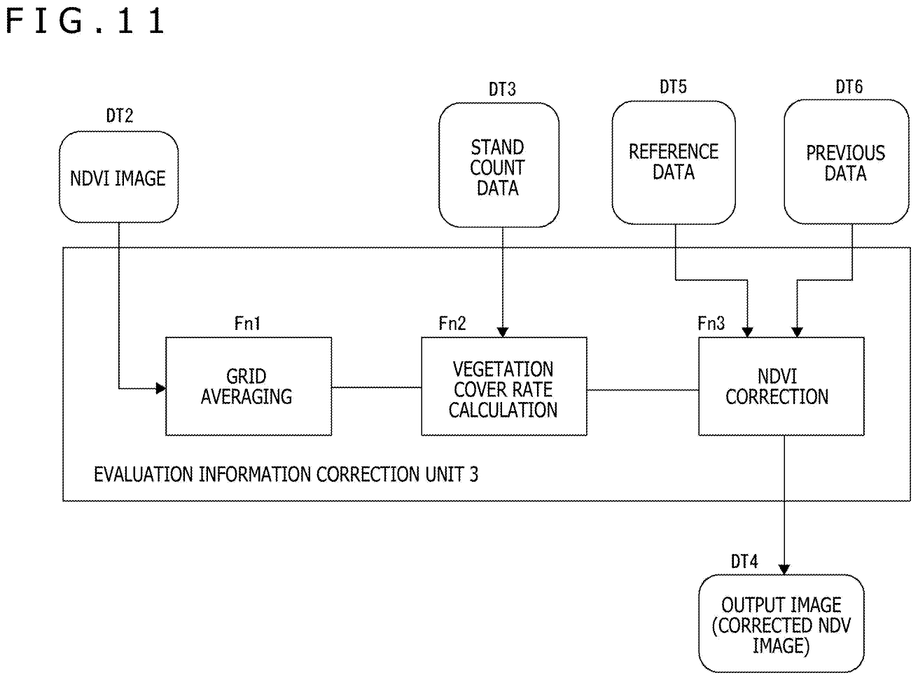

The evaluation information correction unit 3 performing the first example of the correction process described above has a functional configuration depicted in FIG. 11. Specifically, the evaluation information correction unit 3 includes a grid averaging function Fn1, a vegetation cover rate calculation function Fn2, and an NDVI correction function Fn3.

The grid averaging function Fn1 is a function which acquires the NDVI image DT2 corresponding to a processing target and performs a process for grid averaging. For example, the process for grid averaging divides the NDVI image DT2 into multiple grid areas Gr as designated grid units and obtains an average NDVI value of each of the grid areas Gr. For example, each of the average NDVI values of the grid areas Gr is calculated from input values of pixels contained in the corresponding grid area Gr.

The vegetation cover rate calculation function Fn2 is a function which acquires the stand count data DT3 of each of the grid areas Gr and calculates a vegetation cover rate of each of the grid areas Gr on the basis of a germination rate obtained from the stand count data DT3.

The NDVI correction function Fn3 is a function which corrects the average NDVI value of each of the grid areas Gr according to the vegetation cover rate. The NDVI correction function Fn3 in the first example of the correction process is particularly a function which achieves correction using a theoretical value of the average NDVI value for each of the grid areas Gr.

For example, the NDVI correction function Fn3 specifies the theoretical value of the average NDVI value corresponding to the vegetation cover rate for each of the grid areas Gr with reference to reference data DT5 or previous data DT6. The NDVI correction function Fn3 generates correction information on the basis of the theoretical value of the average NDVI value for each of the grid areas Gr and corrects the average NDVI values on the basis of the correction information.

Moreover, the NDVI correction function Fn3 outputs the corrected NDVI image DT4 on the basis of the corrected average NDVI value of each of the grid areas Gr.

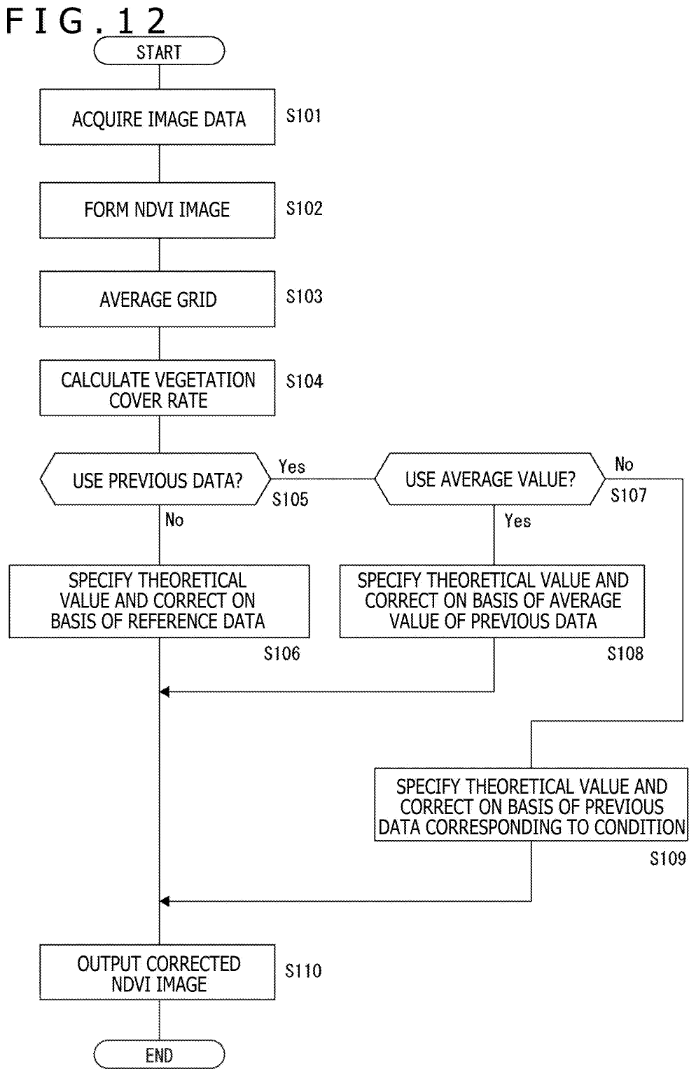

A specific processing example of the first example of the correction process will be described with reference to FIG. 12.

FIG. 12 illustrates a series of processes performed by the CPU 51 for achieving necessary processing for image data corresponding to a processing target until the corrected NDVI image DT4 is output. These processes are practiced by the CPU 51 equipped with the functions explained with reference to FIGS. 2 and 11.

In step S101, the CPU 51 acquires the captured image DT1 (image data) corresponding to a processing target. For example, the CPU 51 acquires an R image and an NIR image as captured images of a farm field corresponding to an observation target.

In step S102, the CPU 51 forms the NDVI image DT2 on the basis of the captured image DT1. For example, the CPU 51 calculates NDVI values of respective pixels of the captured image DT1 and sets the calculated NDVI values for the respective pixels to form the NDVI image DT2.

In step S103, the CPU 51 performs a grid averaging process for the NDVI image DT2. Specifically, the CPU 51 divides the NDVI image DT2 into multiple grid areas Gr as designated grid units and calculates an average NDVI value for each of the grid areas Gr.

In step S104, the CPU 51 calculates a vegetation cover rate for each of the grid areas Gr. Specifically, the CPU 51 acquires the stand count data DT3 of each of the grid areas Gr and calculates a vegetation cover rate of each of the grid areas Gr on the basis of a germination rate obtained from the stand count data DT3.

In step S105, the CPU 51 determines whether or not to use the previous data DT6. For example, the CPU 51 determines use of this data on the basis of a determination setting value or the like.

In a case of determination that the previous data DT6 is not to be used in step S105, the CPU 51 advances the process from step S105 to step S106. In step S106, the CPU 51 acquires the reference data DT5 corresponding to the types of crops in the grid areas Gr. The CPU 51 specifies a theoretical NDVI value corresponding to the vegetation cover rate for each of the grid areas Gr with reference to the reference data DT5. The CPU 51 generates correction information on the basis of the theoretical NDVI value for each of the grid areas Gr and corrects the average NDVI values on the basis of the correction information.

In a case of determination that the previous data DT6 is to be used in step S105, the CPU 51 advances the process from step S105 to step S107. In step S107, the CPU 51 determines whether or not to use average values of the previous data DT6. For example, the CPU 51 determines use of the average values on the basis of a determination setting value or the like.

In a case of determination that the average values are to be used in step S107, the CPU 51 advances the process from step S107 to step S108. In step S108, the CPU 51 acquires average value data of the previous data DT6 of the grid areas Gr or the farm field containing the grid areas Gr. The CPU 51 specifies a theoretical NDVI value corresponding to the vegetation cover rate for each of the grid areas Gr with reference to the acquired data. The CPU 51 generates correction information on the basis of the theoretical NDVI value for each of the grid areas Gr and corrects the average NDVI values on the basis of the correction information.

In a case of determination that the average values are not to be used in step S107, the CPU 51 advances the process from step S107 to step S109. In step S109, the CPU 51 acquires the previous data DT6 corresponding to a condition of the grid areas Gr from the previous data DT6 of the farm field containing the grid areas Gr. For example, measurement data in a season having a climate condition similar to a climate condition in the grid areas Gr is acquired as the previous data DT6 corresponding to the condition. The CPU 51 specifies a theoretical NDVI value corresponding to the vegetation cover rate for each of the grid areas Gr with reference to the acquired data. The CPU 51 generates correction information on the basis of the theoretical NDVI value for each of the grid areas Gr and corrects the average NDVI values on the basis of the correction information.

The CPU 51 having corrected the NDVI values of the respective grid areas Gr in step S106, S108, or S109 advances the process to step S110. In step S110, the CPU 51 outputs the corrected NDVI image DT4 based on the corrected average NDVI values of the respective grid areas Gr.

The corrected NDVI image DT4 is acquired by the foregoing processes. The corrected NDVI image DT4 is stored in the storage unit 59 or the like and displayed on the display unit 56 according to an operation performed by the user, for example.

### <6. Second Example of NDVI Correction Process>

A second example of the NDVI correction process will subsequently be described. The second example of the NDVI correction process classifies target areas into clusters according to vegetation cover rates and then corrects average NDVI values in the respective target areas. Moreover, this example acquires average NDVI values of the respective target areas at different points of time and corrects the average NDVI values in the respective target areas by utilizing information indicating daily changes of the average NDVI values.

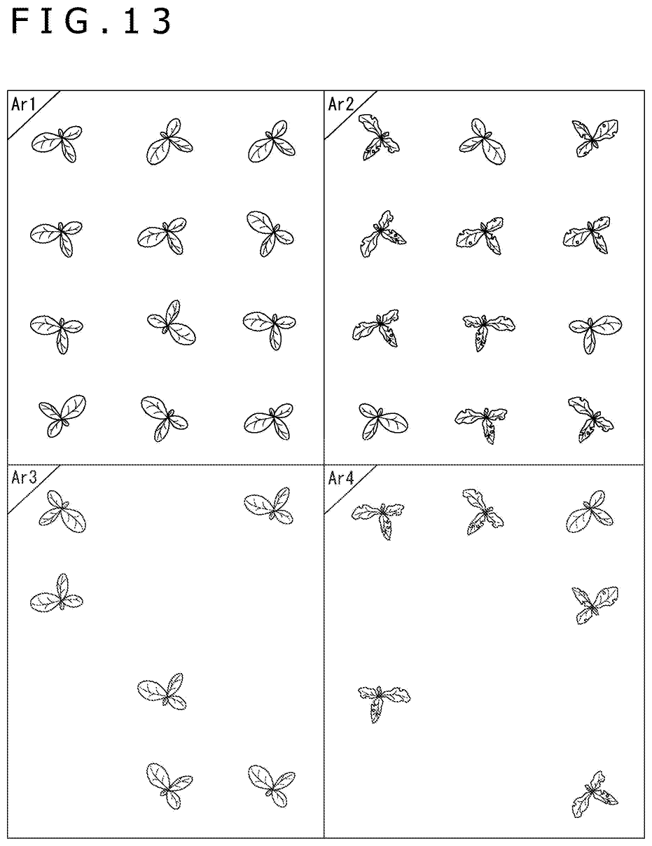

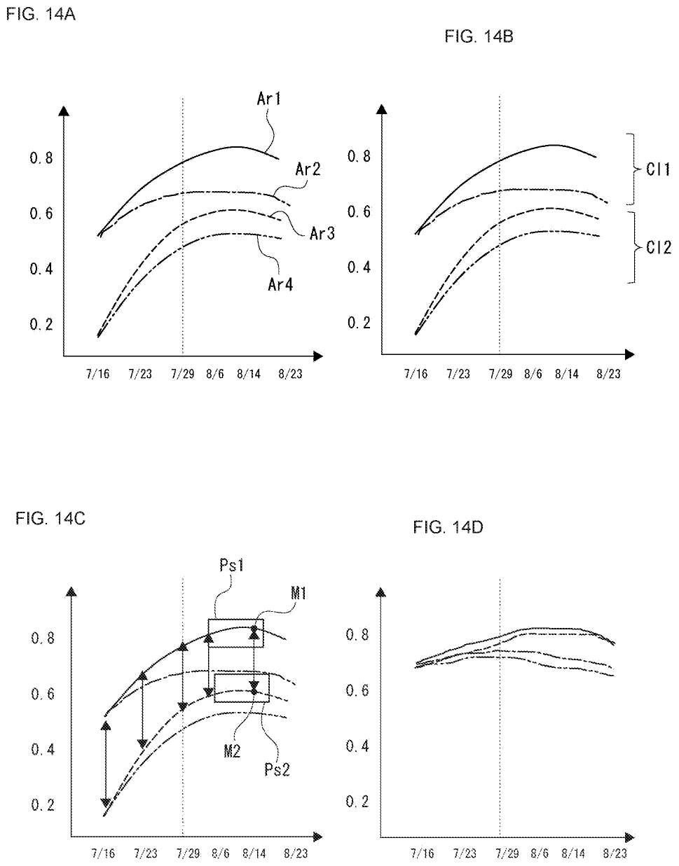

A specific correction example of the second example will be described with reference to FIGS. 13 and 14.

FIG. 13 depicts an example of four types of areas Ar1, Ar2, Ar3, and Ar4 which are included in a farm field and are assumed when a vegetation cover rate and activity of vegetation are designated as references. Specifically, each of the areas Ar1 and Ar2 is an area having a high vegetation cover rate and a relatively small proportion of soil. The area Ar1 also exhibits high activity of vegetation while the area Ar2 exhibits low activity of vegetation. Moreover, each of the areas Ar3 and Ar4 is an example of an area having a low vegetation cover rate and a large proportion of soil. The area Ar3 exhibits high activity of vegetation while the area Ar4 exhibits low activity of vegetation as well.

Described hereinafter will be an example which corrects average NDVI values of the grid areas Gr corresponding to the four types of areas Ar1, Ar2, Ar3, and Ar4 depicted in FIG. 13.

FIG. 14A is a diagram illustrating a daily change of average NDVI values of the areas Ar1, Ar2, Ar3, and Ar4 during a measurement period from July 16 to August 23. A vertical axis represents NDVIs while a horizontal axis represents dates. A solid line indicates a daily change of the average NDVI value of the area Ar1, a one-dot chain line indicates that change of the area Ar2, a broken line indicates that change of the area Ar3, and a two-dot chain line indicates that change of the area Ar4.

Each of the average NDVI values of the areas Ar1, Ar2, Ar3, and Ar4 gradually increases with growth of crops after July 16. As obvious from comparison of a daily change of the average NDVI value between the areas Ar1 and Ar2 each having a high vegetation cover rate, the average NDVI value in the area Ar1 exhibiting high activity of vegetation becomes the maximum on August 14. This increase stops and is stabilized in a period around August 14. The average NDVI value of the area Ar2 exhibiting low activity of vegetation stops increasing at an earlier timing than the increase of the average NDVI value of the area Ar1, and a rate of this increase is low. In addition, concerning the areas Ar3 and Ar4 each having a low vegetation cover rate, the average NDVI value in the area Ar3 exhibiting high activity of vegetation similarly becomes the maximum on August 14. This increase stops and is stabilized in a period around August 14. The average NDVI value of the area Ar4 exhibiting low activity of vegetation stops increasing at an earlier timing than the increase of the average NDVI value of the area Ar3 exhibiting high activity of vegetation, and a rate of this increase is low.

Meanwhile, the average NDVI values of the areas Ar3 and Ar4 each having a low vegetation cover rate are constantly lower than the average NDVI values of the areas Ar1 and Ar2 each having a high vegetation cover rate in the measurement period. For example, the average NDVI values of the area Ar1 and the area Ar3 each exhibiting high activity of vegetation produce similar daily changes. In this case, the average NDVI values of the areas Ar3 and Ar4 are considered to be lower than the average NDVI values of the areas Ar1 and Ar2 due to an influence of the low vegetation cover rates (i.e., a large proportion of soil in each of the areas). Accordingly, it is preferable to make correction considering the vegetation cover rates.

For achieving correction, the grid areas Gr corresponding to processing targets are initially classified into a first cluster C11 having high vegetation cover rates and a second cluster C12 having low vegetation cover rates, according to the vegetation cover rates. According to the present correction example, the areas Ar1 and Ar2 are classified into the first cluster C11 having high vegetation cover rates while the areas Ar3 and Ar4 are classified into the second cluster C12 having low vegetation cover rates as illustrated in FIG. 14B.

Moreover, for achieving correction, a maximum value in the average NDVI values is extracted from each of the clusters. The maximum value in the average NDVI values refers to a maximum value or a value close to the maximum of the average NDVI value in a period where the increase of the average NDVI value substantially reaches a stop and comes into a stable state.

As illustrated in FIG. 14C, the average NDVI value of the area Ar1 comes into a stable state during a period Ps1 including August 14 and becomes the maximum on August 14 in the first cluster C11. Accordingly, the average NDVI value of the area Ar1 on August 14 is extracted as a maximum value M1 in the average NDVI values of the first cluster C11.

Similarly, the average NDVI value of the area Ar3 comes into a stable state during a period Ps2 including August 14 and becomes the maximum on August 14 in the second cluster C12. Accordingly, the average NDVI value of the area Ar3 on August 14 is extracted as a maximum value M2 in the average NDVI values of the second cluster C12.

The second example of the correction process achieves offset correction between clusters on the basis of the maximum values M1 and M2 thus specified in the average NDVI values of the respective clusters.

Specifically, a difference between the maximum value M1 of the first cluster C11 and the maximum value M2 of the second cluster C12 is obtained, and an offset amount is calculated on the basis of the difference. The average NDVI value of each of the areas Ar3 and Ar4 classified into the second cluster C12 is corrected on the basis of the calculated offset amount.

Each of the average NDVI values of the areas classified into the second cluster C12 has a low vegetation cover rate and therefore is considered to be lower than an actual NDVI value of vegetation. Accordingly, the average NDVI values are corrected such that the maximum value M1 of the first cluster C11 and the maximum value M2 of the second cluster C12 are equalized, for example.

Moreover, the second example of the correction process achieves ratio correction on the basis of a ratio calculated from the maximum value M1 of the average NDVI values of the first cluster C11.

For example, concerning the maximum value M1 of the first cluster C11, the second example obtains a theoretical value of the average NDVI value of the area Ar1 from which the maximum value M1 has been extracted, and makes correction on the basis of a ratio of the maximum value M1 to this theoretical value. This ratio represents a ratio of the NDVI maximum value M1 in the area Ar1 at the time when the vegetation cover rate is assumed to be the highest, to a theoretical NDVI value in a case where the vegetation cover rate is 100%. Accordingly, by correcting the average NDVI value of each of the areas Ar1, Ar2, Ar3, and Ar4 on the basis of the foregoing ratio, the average NDVI value on an assumption that the vegetation cover rate is 100% can be acquired for each of the areas.

FIG. 14D illustrates average NDVI values obtained by correcting the average NDVI values illustrated in FIGS. 14A to 14C on the basis of the offset correction and the ratio correction, for each of the areas Ar1, Ar2, Ar3, and Ar4.

As obvious from comparison of daily changes of the average NDVI values between the areas Ar1, Ar2, Ar3, and Ar4 before and after the correction, the average NDVI value of the area Ar3 has been changed to a value higher than the average NDVI value of the area Ar2 in the entire period, for example.

Moreover, as obvious from comparison of daily changes of the average NDVI values between the area Ar3 and the area Ar4 each having a low vegetation cover rate in FIG. 14D, the average NDVI values of both of the areas Ar3 and Ar4 increase until July 29. However, after July 29, the average NDVI value of the area Ar3 continuously increases, but the average NDVI value of the area Ar4 stops increasing. Similarly, as for the area Ar1 and the area Ar2 each having a high vegetation cover rate, the average NDVI value of the area Ar1 continuously increases but the average NDVI value of the area Ar2 stops increasing after July 29. It is estimated that a portion indicating a low average NDVI value after correction made according to a vegetation cover rate corresponds to an area where NDVI values are lowered by lowering of activity of vegetation caused by insufficiency of nitrogen at that time or for other reasons. Accordingly, it is considered that an action such as additional fertilization is to be set for the areas Ar2 and Ar4 each indicating a low average NDVI value after July 29, for example.

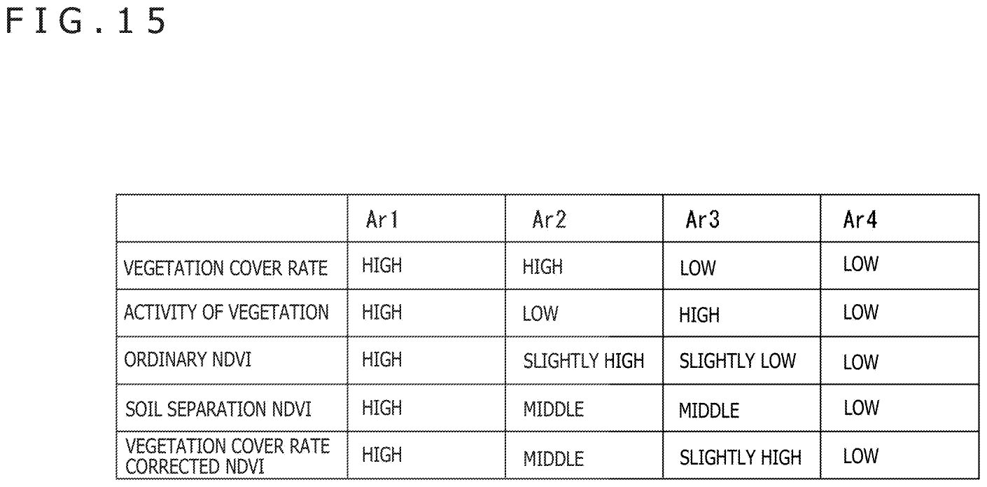

FIG. 15 is a table illustrating a relative relation between average NDVI values calculated by ordinary NDVI measurement (ordinary NDVI), NDVI measurement by soil separation (soil separation NDVI), and correction in the second example of the correction process (vegetation cover rate corrected NDVI) for each of the areas Ar1, Ar2, Ar3, and Ar4 described above.

In the ordinary NDVI measurement, the calculated average NDVI values of the areas Ar1 and Ar2 each having a high vegetation cover rate are higher than the average NDVI values of the areas Ar3 and Ar4 each having a low vegetation cover rate. In this case, the calculated average NDVI value of the area Ar2 exhibiting low activity of vegetation is relatively high, for example. Accordingly, there is a possibility that the area Ar2 is not determined as an area exhibiting low activity of vegetation.

Moreover, an influence of soil is removed in the NDVI measurement by soil separation. Hence, the average NDVI value of the area Ar3 is higher than the average NDVI value obtained by the ordinary NDVI measurement, for example. Meanwhile, the average NDVI values of the area Ar2 and the area Ar3 are substantially equivalent to each other. Accordingly, a distinction between the area actually exhibiting low activity of vegetation and the area having a low vegetation cover rate but exhibiting high activity of vegetation is difficult to make on the basis of the NDVI values.

On the other hand, when the correction according to the second example of the correction process is applied, the calculated average NDVI value of the area Ar2 is lower than the average NDVI values of the areas Ar1 and Ar3 each exhibiting high activity of vegetation. Moreover, while the average NDVI value of the area Ar2 is a “middle” value, the average NDVI value of the area Ar3 is a “slightly high” value. The influence of the lowering of the NDVIs caused by the low vegetation cover rate has been removed from the NDVI values after correction. Accordingly, it is estimated that the average NDVI value of the area Ar2 is slightly low according to the low activity of vegetation. In this manner, even the areas not distinguishable by soil separation become distinguishable by applying correction according to the vegetation cover rates.

Moreover, the four types of areas Ar1, Ar2, Ar3, and Ar4, which are assumed when the vegetation cover rate and the activity of vegetation are designated as references, are distinguishable on the basis of the NDVI values after correction. Accordingly, an action corresponding to the vegetation cover rate and the activity of vegetation can be determined for each of the areas with reference to the NDVI values after correction.

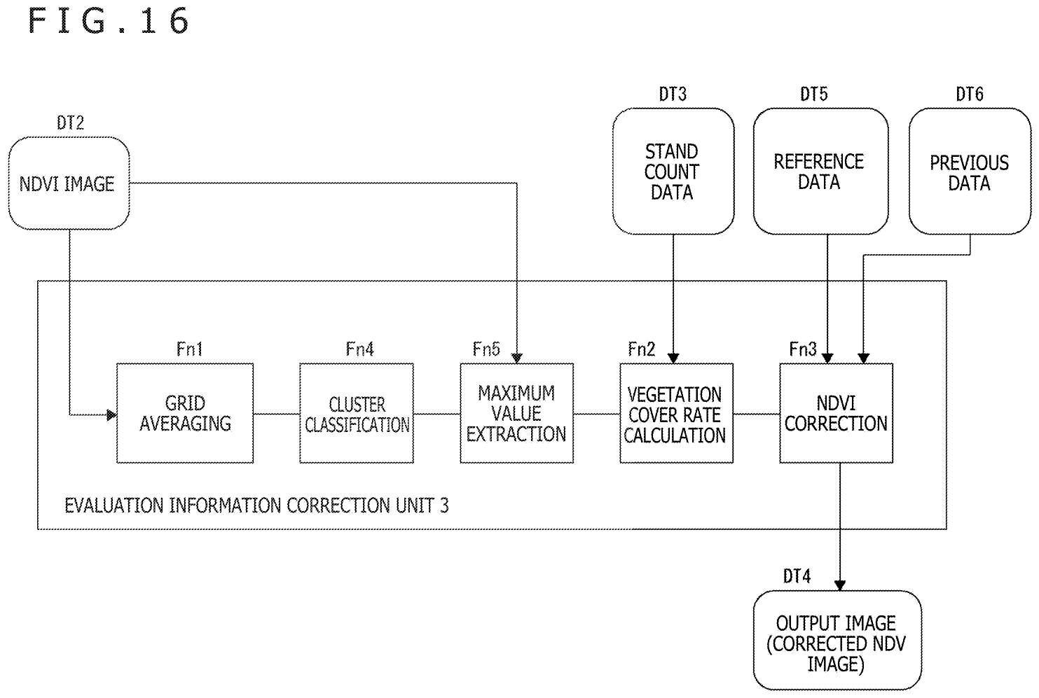

The evaluation information correction unit 3 performing the second example of the correction process described above has a functional configuration depicted in FIG. 16. Specifically, the evaluation information correction unit 3 includes the grid averaging function Fn1, a cluster classification function Fn4, a maximum value extraction function Fn5, the vegetation cover rate calculation function Fn2, and the NDVI correction function Fn3.

Note that functions similar to the functions described with reference to FIG. 11 are given the same reference signs and not further explained in detail, and that an operation particularly performed in the second example of the correction process will chiefly be described.

The grid averaging function Fn1 is a function which acquires the NDVI images DT2 corresponding to a processing target and performs a process for grid averaging. Note that multiple NDVI images DT2 corresponding to different points of time are acquired in the second example of the correction process.

The vegetation cover rate calculation function Fn2 is a function which acquires the stand count data DT3 of each of the grid areas Gr and calculates a vegetation cover rate of each of the grid areas Gr on the basis of a germination rate obtained from the stand count data DT3.

The cluster classification function Fn4 is a function of classifying the grid areas Gr into clusters. For example, the cluster classification function Fn4 classifies the respective grid areas Gr into a first cluster C11 having high vegetation cover rates and a second cluster C12 having low vegetation cover rates, according to vegetation cover rates of the respective grid areas Gr.

Moreover, the cluster classification function Fn4 may further classifies the grid areas Gr according to average NDVI values after classification into the first cluster C11 and the second cluster C12. In this case, the cluster classification function Fn4 achieves classification into a first group having high vegetation cover rates and high average NDVI values, a second group having high vegetation cover rates and low average NDVI values, a third group having low vegetation cover rates and high average NDVI values, and a fourth group having low vegetation cover rates and low average NDVI values.

The maximum value extraction function Fn5 is a function of extracting a maximum value in average NDVI values in each of the clusters. For example, the maximum value extraction function Fn5 acquires the NDVI images DT2 and extracts a maximum value M1 from the average NDVI values of the first cluster C11 and a maximum value M2 from the average NDVI values of the second cluster C12. Moreover, in a case of classification into the four clusters based on vegetation cover rates and NDVI values, the maximum value extraction function Fn5 extracts a maximum value in the average NDVI values from each of the first group having high vegetation cover rates and high average NDVI values and the third group having low vegetation cover rates and high average NDVI values.

The NDVI correction function Fn3 is a function which corrects NDVI values of the grid areas Gr according to vegetation cover rates. The NDVI correction function Fn3 in the second example of the correction process is a function which particularly achieves offset correction and ratio correction between clusters.

For example, for achieving the offset correction, the NDVI correction function Fn3 obtains a difference between the maximum value M1 in the average NDVI values of the first cluster C11 and the maximum value M2 in the average NDVI values of the second cluster C12, generates correction information on the basis of the difference, and corrects the average NDVI values of the respective grid areas Gr classified into the second cluster C12, on the basis of the correction information. For example, the correction information applied to the offset correction is an offset amount.

Moreover, for achieving the ratio correction, the NDVI correction function Fn3 designates the grid area Gr from which the maximum value M1 has been extracted, as a maximum value area, specifies a theoretical value of the NDVI for the maximum value area, generates correction information on the basis of the maximum value M1 and this theoretical value, and corrects the average NDVI values of the respective grid areas Gr in the first cluster C11 and the second cluster C12 on the basis of the correction information. Note that the average NDVI values of the grid areas Gr to be corrected may be either those classified into the first cluster C11 or those classified into the second cluster C12. For example, the correction information applied to the ratio correction is a ratio of the theoretical value of the maximum value area to the maximum value M1. Note that the NDVI correction function Fn3 refers to the reference data DT5 or the previous data DT6 to specify the theoretical value of the maximum value area.

Moreover, the NDVI correction function Fn3 outputs the corrected NDVI image DT4 on the basis of the corrected average NDVI value of each of the grid areas Gr.

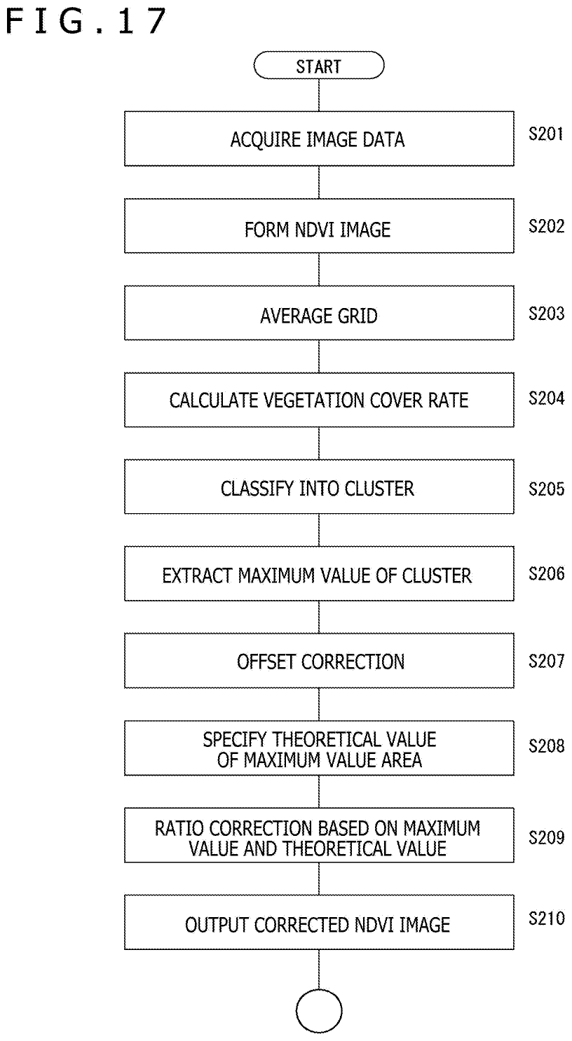

A specific processing example of the second example of the correction process will be described with reference to FIG. 17.

FIG. 17 illustrates a series of processes performed by the CPU 51 for achieving necessary processing for image data corresponding to a processing target until the corrected NDVI image is output. These processes are practiced by the CPU 51 equipped with the functions explained with reference to FIGS. 2 and 16.

In step S201, the CPU 51 acquires the captured images DT1 (image data) corresponding to a processing target. For example, the CPU 51 acquires multiple captured images DT1 at different points of time for a farm field corresponding to an observation target.

In step S202, the CPU 51 forms the NDVI images DT2 on the basis of the captured images DT1. For example, the CPU 51 calculates NDVI values of respective pixels of the captured images DT1 and sets the calculated NDVI values for the respective pixels to form the NDVI images DT2. Note that the CPU 51 forms the NDVI images DT2 one for each of the captured images DT1 at the respective points of time.

In step S203, the CPU 51 performs a grid averaging process for each of the NDVI images DT2 at the respective points of time. Specifically, the CPU 51 divides the NDVI image DT2 into multiple grid areas Gr as designated grid units and calculates an average NDVI value for each of the grid areas Gr. Note that the NDVI images DT2 at the respective points of time are each divided into multiple grid areas Gr as units of an identical grid so as to calculate the average NDVI value for each different point of time in each of the grid areas Gr.

In step S204, the CPU 51 calculates a vegetation cover rate for each of the grid areas Gr. Specifically, the CPU 51 acquires the stand count data DT3 of each of the grid areas Gr and calculates a vegetation cover rate for each of the grid areas Gr on the basis of a germination rate obtained from the stand count data DT3.

In step S205, the CPU 51 classifies the grid areas Gr into clusters. For example, the CPU 51 classifies the multiple grid areas Gr into a first cluster C11 having high vegetation cover rates and a second cluster C12 having low vegetation cover rates, according to vegetation cover rates of the respective grid areas Gr.

In step S206, the CPU 51 extracts a maximum value in the average NDVI values from each of the clusters. Specifically, the CPU 51 extracts a maximum value M1 from the average NDVI values of the first cluster C11 and a maximum value M2 from the average NDVI values of the second cluster C12.

In step S207, the CPU 51 achieves offset correction between the clusters. Specifically, the CPU 51 obtains a difference between the maximum value M1 in the average NDVI values and the maximum value M2 in the average NDVI values of the second cluster C12, generates correction information on the basis of the difference, and corrects the average NDVI values of the respective grid areas Gr classified into the second cluster C12, on the basis of the correction information.

Subsequently, the CPU 51 achieves ratio correction by processes in step S208 and step S209.

In step S208, the CPU 51 designates the grid area Gr from which the maximum value M1 of the first cluster C11 has been extracted, as a maximum value area, and obtains a theoretical value of the NDVI value in the maximum value area. In step S209, the CPU 51 generates correction information on the basis of the maximum value M1 of the first cluster C11 and the theoretical value of the maximum value area obtained in step S208 and corrects the average NDVI values in the respective grid areas Gr on the basis of the correction information.

In step S210, the CPU 51 outputs the corrected NDVI image DT4 based on the corrected average NDVI values of the respective grid areas Gr. The CPU 51 may form either the corrected NDVI images DT4 at the respective points of time or the corrected NDVI image DT4 at a part of the points of time selected by the user, for example.

The corrected NDVI image DT4 is acquired by the foregoing processes. The corrected NDVI image DT4 is stored in the storage unit 59 or the like and displayed on the display unit 56 according to an operation performed by the user, for example.

While the processing example in FIG. 17 has been the process where the CPU 51 classifies the grid areas Gr into the first cluster C11 and the second cluster C12 according to vegetation cover rates in step S205, the CPU 51 may classify the grid areas Gr into the first group having high vegetation cover rates and high NDVI values, the second group having high vegetation cover rates and low NDVI values, the third group having low vegetation cover rates and high NDVI values, and the fourth group having low vegetation cover rates and low NDVI values, on the basis of vegetation cover rates and NDVI values. In this case, the CPU 51 specifies the maximum value for each of the first group and the third group each having high NDVI values in step S206.

While described in the processing example in FIG. 17 has been the example where the offset correction in step S207 and the ratio correction achieved by the processes in step S208 and step S209 are performed in this order, these corrections may be carried out in an opposite order. Moreover, only either one of these corrections may be executed.

Further, while the processing example in FIG. 17 has been the example where the corrected NDVI image DT4 is output in step S210, information indicating daily changes of the average NDVI values in the respective grid areas Gr as illustrated in FIG. 14D may be output, for example, instead of the corrected NDVI image DT4.

### <7. Summary and Modifications>

The embodiment described above can offer following advantageous effects.

The information processing device 1 according to the embodiment includes the evaluation information correction unit 3 which corrects evaluation information (average NDVI value) associated with a target area (grid area Gr) according to correction information based on the number of crops in this target area.

In a case where the number of crops in the grid area Gr is small, a proportion of a soil part in a captured image of the grid area Gr increases. In this case, an average NDVI value which is associated with the corresponding grid area Gr and is calculated from the captured image decreases. Accordingly, the decrease in the average NDVI value caused by a large proportion of the soil part in the captured image is reduced by correcting the average NDVI value of the corresponding grid area Gr according to the correction information based on the number of crops. In this manner, an average NDVI value appropriately reflecting a state of vegetation in the grid area Gr can be obtained. That is, accuracy of the average NDVI value of the grid area Gr can be improved. In other words, accuracy of evaluation information acquired by sensing can be improved. As a result, an appropriate action can be determined according to a state of vegetation, such as variable fertilization.

Note that the correction information is information applied to correction of evaluation information such as NDVI values and refers to the correction level of NDVI values described in the first example of the NDVI correction process, and the offset amount and the ratio described in the second example of the NDVI correction process, for example. Note that the correction information is not limited to the example presented in the embodiment and may be various rates and values.

While the example of the grid area Gr defined in the farm field 210 has been presented as the target area in the embodiment, an area defined in the farm field 210 by other methods may be designated as the target area.

According to the example presented in the embodiment, the evaluation information correction unit 3 obtains a vegetation cover rate from the number of crops in the target area (grid area Gr) and generates correction information on the basis of this vegetation cover rate (see FIGS. 12 and 17).

The vegetation cover rate of the grid area Gr represents a proportion of plants covering a ground surface (soil) in the grid area Gr. Accordingly, correction considering a proportion of the soil part in the grid area Gr can be made by correcting the average NDVI value of the grid area Gr according to correction information generated on the basis of the vegetation cover rate of the corresponding grid area Gr.

According to the example presented in the embodiment, the evaluation information correction unit 3 specifies a theoretical value of evaluation information (theoretical NDVI value) on the basis of a vegetation cover rate and generates correction information associated with the target area (grid area Gr) on the basis of this theoretical value (see FIGS. 8, 12, and 17).

The theoretical NDVI value refers to a theoretical value of an NDVI assumed for a specific vegetation cover rate. Specifically, the theoretical NDVI value is an NDVI value estimated to be obtained when an influence of a soil part is removed from the grid area Gr having a specific vegetation cover rate. Accordingly, correction considering a proportion of the soil part in the grid area Gr can be made by correcting the average NDVI value of the grid area Gr according to correction information generated on the basis of the theoretical NDVI value.

According to the example presented in the embodiment, the evaluation information correction unit 3 specifies a theoretical value on the basis of a vegetation cover rate according to the reference data DT5 corresponding to a type of crops in the target area (grid area Gr) (see FIGS. 8 and 12).

For example, the reference data DT5 is data indicating a correlation between a vegetation cover rate of a certain type of crops and a theoretical value of evaluation information.

A correlation between a vegetation cover rate and a theoretical NDVI value differs for each type of crops. Accordingly, a theoretical value corresponding to the type of crops growing in the grid area Gr can be specified with reference to the reference data DT5 corresponding to the type of crops in the grid area Gr.

According to the example presented in the embodiment, the evaluation information correction unit 3 specifies a theoretical value of evaluation information on the basis of a vegetation cover rate according to the previous data DT6 previously measured in the target area (grid area Gr) (see FIGS. 8 and 12).

For example, the previous data DT6 of the grid area Gr refers to data indicating a correlation between a vegetation cover rate previously measured and an NDVI value in the grid area Gr or a farm field including the grid area Gr.

For example, a correlation between a vegetation cover rate and a theoretical NDVI value differs for each farm field due to a difference in an environment factor such as soil and sunlight. Accordingly, a theoretical value corresponding to a state of the grid area Gr can be specified with reference to the previous data DT6 of the grid area Gr or the farm field 210 including the grid area Gr.

According to the example presented in the embodiment, the evaluation information correction unit 3 specifies a theoretical value on the basis of a vegetation cover rate according to the previous data DT6 corresponding to a condition of the target area (grid area Gr) (see FIGS. 8 and 12).

For example, a correlation between a vegetation cover rate and a theoretical NDVI value changes for each season even in the same farm field due to differences in various conditions such as a climate condition. Accordingly, in a case where data of correlations between vegetation cover rates measured under different conditions and theoretical NDVI values is available, a theoretical NDVI value corresponding to a condition of the grid area Gr can be specified with reference to the correlation indicated by the previous data DT6 corresponding to the condition of the grid area Gr or the farm field 210 including the grid area Gr.

According to the example presented in the embodiment, the target area (grid area Gr) is a partial area of the farm field 210, and the evaluation information correction unit 3 corrects evaluation information (average NDVI values) associated with multiple target areas (multiple grid areas Gr) in the farm field 210 (see FIGS. 10, 14, and 15).

In this manner, the multiple grid areas Gr in the farm field 210 are corrected according to respective numbers of crops. Accordingly, for example, a decrease in average NDVI values caused by a large volume of soil parts can be reduced, and therefore, relative comparison among average NDVI values of the respective areas in the farm field 210 is achievable. In other words, relative comparison among chlorophyll concentrations in the respective areas in the farm field 210 is achievable.

Note that the farm field 210 includes a wide variety of farms where agricultural crops are cultivated, such as a crop cultivation area, a cultivated land, a hydroponic cultivation area, a greenhouse cultivation area.

According to the example presented in the embodiment, the evaluation information correction unit 3 obtains a vegetation cover rate for each of multiple target areas (grid areas Gr or areas Ar1, Ar2, Ar3, and Ar4), classifies the multiple target areas into the first cluster C11 having high vegetation cover rates and the second cluster C12 having low vegetation cover rates, and corrects evaluation information (average NDVI values) of at least the target areas (areas Ar3 and Ar4) classified into the second cluster C12 (see FIGS. 14 and 17).

An area group whose average NDVI values have decreased due to an influence of low vegetation cover rates can be specified by classifying the grid areas Gr into the first cluster C11 having high vegetation cover rates and the second cluster C12 having low vegetation cover rates. In other words, it is possible to specify an area group for which correction according to vegetation cover rates is preferable.

According to the example presented in the embodiment, the evaluation information correction unit 3 corrects evaluation information (average NDVI value) for each of the target areas classified into the first cluster C11 (grid areas Gr or areas Ar1 and Ar2) and the target areas classified into the second cluster C12 (grid areas Gr or areas Ar3 and Ar4) (see FIGS. 14 and 17).

Correction corresponding to vegetation cover rates can appropriately be achieved by classifying the multiple grid areas Gr into the first cluster C11 having high vegetation cover rates and the second cluster C12 having low vegetation cover rates, and achieving correction for each of the clusters. Moreover, while an influence level is low in comparison with the grid areas Gr classified into the second cluster C12, the average NDVI values of the grid areas Gr classified into the first cluster C11 are also influenced by the soil part included in the captured image. Accordingly, overall accuracy of the average NDVI values in the respective areas in the farm field 210 can be raised by correcting the average NDVI values of the grid areas Gr in the first cluster C11 in addition to the grid areas Gr in the second cluster C12.

According to the example presented in the embodiment, the evaluation information correction unit 3 obtains evaluation information (average NDVI values) associated with each of multiple target areas (grid areas Gr or areas Ar1, Ar2, Ar3, and Ar4) at different points of time, obtains a difference between the maximum value M1 of evaluation information associated with the first cluster C11 and the maximum value M2 of evaluation information associated with the second cluster C12, and generates correction information (offset amount) for each of the target areas (areas Ar3 and Ar4) classified into the second cluster C12 on the basis of the difference (see FIGS. 14 and 17).

In this manner, a gap in the average NDVI value between the clusters can be offset. Specifically, the average NDVI values of the grid areas Gr classified into the second cluster C12 having low vegetation cover rates are considered to be lower than actual NDVI values of vegetation in the corresponding grid areas Gr. Accordingly, for example, an influence of low vegetation cover rates can be reduced by achieving such an offset that the maximum value M1 of the first cluster C11 and the maximum value M2 of the second cluster C12 are equalized. In addition, in a case where the average NDVI values at different points of time are corrected, either the same offset amount or a different offset amount may be used for each of the points of time. In a case where a different offset amount is used for each of the points of time, it is possible to calculate the offset amount for each of the points of time by using predetermined coefficients or the like, for example, at the time of calculation (generation) of the offset amount on the basis of the difference.

Moreover, while the offset amount is calculated on the basis of the difference between the maximum values of the average NDVI values of the respective clusters according to the embodiment, the offset amount may be calculated on the basis of a difference between representative values of evaluation information associated with the respective clusters and extracted on the basis of other references, such as a difference between maximum values of the average NDVI values of the respective clusters on a predetermined date designated by the user.

According to the example presented in the embodiment, the evaluation information correction unit 3 in the second example of the NDVI correction process acquires evaluation information (average NDVI values) for each of multiple target areas (grid areas Gr or areas Ar1, Ar2, Ar3, and Ar4) at different points of time, extracts the maximum value M1 of evaluation information in the first cluster C11, designates the target area (area Ar) from which the maximum value M1 has been extracted, as the maximum value area, obtains a theoretical value of the evaluation information on the basis of a vegetation cover rate of the maximum value area, and corrects evaluation information associated with the multiple target areas on the basis of correction information generated from the maximum value M1 and this theoretical value (see FIGS. 14 and 17).

It is possible that the correction information generated from the theoretical value of the maximum value area (area Ar) and the maximum value M1 is a ratio of this theoretical value to the maximum value M1, for example. The average NDVI value on an assumption that the vegetation cover rate is 100% can be acquired for each of the areas by correcting the average NDVI values of the multiple target areas on the basis of this ratio. In other words, NDVI values less influenced by the vegetation cover rates can be acquired. Note that, while presented in the embodiment has been the example which designates the ratio of the theoretical value of the maximum value area to the maximum value M1 as the correction information, rates or values other than the ratio generated from the theoretical value of the maximum value area and the maximum value M1 may be adopted as the correction information.

Presented in the embodiment has been the example where the number of crops of the target area (grid area Gr) is obtained from image data of the corresponding target area.

The number of crops is a stand count value obtained from image data acquired by imaging the grid area Gr or the farm field 210 including the grid area Gr, for example. The stand count value is calculated for determining replanting (e.g., reseeding) after planting, for example. However, in a case where the stand count value is made available as the stand count data DT3, for example, the number of crops in the target area can be acquired without the necessity of newly measuring the number of crops in the target area.

Note that, while described in the embodiment has been the example where a stand count value is adopted as the number of crops, an input value from the user or the number of crops measured by other methods may be adopted as the number of crops in the target area.

Presented in the embodiment has been the example where evaluation information associated with the target area (grid area Gr) is a vegetation index.

In this manner, accuracy of evaluation information as a vegetation index for evaluating vegetation in the target area can be improved. For example, according to the embodiment, accuracy for estimating chlorophyll concentration on the basis of corrected average NDVI values can be improved.

Note that, while described in the embodiment has been the example which corrects NDVI values (average NDVI values) as evaluation information, evaluation information indicating other vegetation indexes may be corrected.

The program according to the embodiment is a program under which a CPU, a DSP (Digital Signal Processor), or the like or a device including any of these, for example, executes a process for correcting evaluation information associated with a target area according to correction information based on the number of crops in the target area.

This program allows the information processing device 1 described above to be provided in a wide range. For example, it is also assumed to provide this program in the form of an update program or the like for the information processing device 1.

The program in the forms described above may be recorded beforehand in an HDD as a storage medium built in an apparatus such as a computer device, a ROM within a microcomputer having a CPU, or the like.

Alternatively, the program may be stored (recorded) temporarily or permanently in a removable storage medium such as a flexible disk, a CD-ROM (Compact Disc Read Only Memory), an MO (Magneto Optical) disk, a DVD (Digital Versatile Disc), a Blu-ray Disc (registered trademark), a magnetic disk, a semiconductor memory, and a memory card. The removable storage medium in the forms described above may be provided as what is generally called package software.

Moreover, the program described above may be installed from a removable recording medium into a personal computer or the like or may be downloaded from a download website via a network such as a LAN (Local Area Network) and the Internet.

Further, the program described above is suitable for providing the information processing device 1 of the embodiment in a wide range. For example, the program may be downloaded to a server that provides a cloud computing service, to implement the functions of the information processing device 1 of the present disclosure on a cloud network.

Note that advantageous effects to be offered are not limited to the advantageous effects presented in the present description only by way of example. In addition, other advantageous effects may be produced.

Note that the present technology can also adopt the following configurations.

(1)

An information processing device including:
an evaluation information correction unit that corrects evaluation information associated with a target area according to correction information based on the number of crops of the target area.
   (2)

The information processing device according to (1) above, in which the evaluation information correction unit obtains a vegetation cover rate from the number of crops in the target area and generates the correction information on the basis of the vegetation cover rate.

(3)

The information processing device according to (2) above, in which the evaluation information correction unit specifies a theoretical value of the evaluation information from the vegetation cover rate and generates the correction information on the basis of the theoretical value.

(4)

The information processing device according to (3) above, in which the evaluation information correction unit specifies the theoretical value from the vegetation cover rate on the basis of reference data corresponding to a type of the crops in the target area.

(5)

The information processing device according to (3) above, in which the evaluation information correction unit specifies the theoretical value from the vegetation cover rate on the basis of previous data previously measured in the target area.

(6)

The information processing device according to (5) above, in which the evaluation information correction unit specifies the theoretical value from the vegetation cover rate on the basis of the previous data corresponding to a condition of the target area.

(7)

The information processing device according to any of (1) through (6) above, in which the target area is a partial area of a farm field, and the evaluation information correction unit corrects evaluation information associated with multiple target areas in the farm field.

(8)

The information processing device according to (1) above, in which the evaluation information correction unit obtains a vegetation cover rate from the number of crops for each of multiple target areas, classifies the multiple target areas into a first cluster having a high vegetation cover rate and a second cluster having a low vegetation cover rate, and corrects at least evaluation information associated with the target area classified into the second cluster.

(9)

The information processing device according to (8) above, in which the evaluation information correction unit corrects evaluation information associated with the target area classified into the first cluster and the evaluation information associated with the target area classified into the second cluster.

(10)

The information processing device according to (8) or (9) above, in which the evaluation information correction unit acquires evaluation information associated with the multiple target areas at different points of time, obtains a difference between a maximum value of evaluation information in the first cluster and a maximum value of evaluation information in the second cluster, and corrects the evaluation information associated with the target area classified into the second cluster, on the basis of correction information generated from the difference.

(11)

The information processing device according to any of (8) through (10) above, in which the evaluation information correction unit acquires evaluation information associated with the multiple target areas at different points of time, extracts a maximum value of evaluation information in the first cluster, designates the target area from which the maximum value has been extracted, as a maximum value area, obtains a theoretical value of evaluation information associated with the maximum value area on the basis of a vegetation cover rate of the maximum value area, and corrects the evaluation information associated with the multiple target areas on the basis of correction information generated from the maximum value and the theoretical value.

(12)

The information processing device according to any of (1) through (11) above, in which the number of crops in the target area is obtained from image data of the target area.

(13)

The information processing device according to any of (1) through (12) above, in which the evaluation information associated with the target area is a vegetation index.

(14)

An information processing method that corrects evaluation information associated with a target area according to correction information based on the number of crops of the target area.

(15)

A program causing an information processing device to execute a process that corrects evaluation information associated with a target area according to correction information based on the number of crops of the target area.

### REFERENCE SIGNS LIST

1: Information processing device
3: Evaluation information correction unit
C11: First cluster
C12: Second cluster
DT1: Captured image
DT2: NDVI image
DT3: Stand count data
DT5: Reference data
DT6: Previous data
Gr: Grid area
M1, M2: Maximum value

1. An information processing device comprising:
an evaluation information correction unit that corrects evaluation information associated with a target area according to correction information based on the number of crops of the target area.

2. The information processing device according to claim 1, wherein the evaluation information correction unit obtains a vegetation cover rate from the number of crops in the target area and generates the correction information on a basis of the vegetation cover rate.

3. The information processing device according to claim 2, wherein the evaluation information correction unit specifies a theoretical value of the evaluation information from the vegetation cover rate and generates the correction information on a basis of the theoretical value.

4. The information processing device according to claim 3, wherein the evaluation information correction unit specifies the theoretical value from the vegetation cover rate on a basis of reference data corresponding to a type of the crops in the target area.

5. The information processing device according to claim 3, wherein the evaluation information correction unit specifies the theoretical value from the vegetation cover rate on a basis of previous data previously measured in the target area.

6. The information processing device according to claim 5, wherein the evaluation information correction unit specifies the theoretical value from the vegetation cover rate on a basis of the previous data corresponding to a condition of the target area.

7. The information processing device according to claim 1, wherein
the target area includes a partial area of a farm field, and
the evaluation information correction unit corrects evaluation information associated with multiple target areas in the farm field.

8. The information processing device according to claim 1, wherein the evaluation information correction unit obtains a vegetation cover rate from the number of crops for each of multiple target areas, classifies the multiple target areas into a first cluster having a high vegetation cover rate and a second cluster having a low vegetation cover rate, and corrects at least evaluation information associated with the target area classified into the second cluster.

9. The information processing device according to claim 8, wherein the evaluation information correction unit corrects evaluation information associated with the target area classified into the first cluster and the evaluation information associated with the target area classified into the second cluster.

10. The information processing device according to claim 8, wherein the evaluation information correction unit acquires evaluation information associated with the multiple target areas at different points of time, obtains a difference between a maximum value of evaluation information in the first cluster and a maximum value of evaluation information in the second cluster, and corrects the evaluation information associated with the target area classified into the second cluster, on a basis of correction information generated from the difference.

11. The information processing device according to claim 8, wherein the evaluation information correction unit acquires evaluation information associated with the multiple target areas at different points of time, extracts a maximum value of evaluation information in the first cluster, designates the target area from which the maximum value has been extracted, as a maximum value area, obtains a theoretical value of evaluation information associated with the maximum value area on a basis of a vegetation cover rate of the maximum value area, and corrects the evaluation information associated with the multiple target areas on a basis of correction information generated from the maximum value and the theoretical value.

12. The information processing device according to claim 1, wherein the number of crops in the target area is obtained from image data of the target area.

13. The information processing device according to claim 1, wherein the evaluation information associated with the target area includes a vegetation index.

14. An information processing method that corrects evaluation information associated with a target area according to correction information based on the number of crops of the target area.

15. A program causing an information processing device to execute a process that corrects evaluation information associated with a target area according to correction information based on the number of crops of the target area.
